(19) United States
(12) Patent Application Publication
(10) Pub. No.: US 2026/0146980 A1
(43) Pub. Date: May 28, 2026

(54) METHODS, MEDIUMS, AND SYSTEMS FOR DETECTING AND INTEGRATING PEAKS IN ANALYTICAL INSTRUMENT DATA

(71) Applicant: Waters Technologies Ireland Limited, Dublin (IE)

(72) Inventors: Marisa Gioioso, Hopkinton, MA (US); Timothy Scott Trinkle, Atlanta, GA (US)

(73) Assignee: Waters Technologies Ireland Limited, Dublin (IE)

(21) Appl. No.: 19/398,992

(22) Filed: Nov. 24, 2025

Related U.S. Application Data
(60) Provisional application No. 63/726,006, filed on Nov. 27, 2024.

(51) Int. Cl. G01N 30/86

(52) U.S. Cl. CPC G01N 30/8631; G01N 30/8696

(57) ABSTRACT

Exemplary embodiments relate to methods, mediums, and systems to improve chromatographic peak detection and integration using machine learning techniques. An analytical integration tool determines peak locations using second derivative local maxima and identifies peak bounds where the second derivative changes sign. Various issues can cause this process to generate false positives or false negatives, or improper peak boundaries. To address this problem, users typically make manual changes to the integrated chromatograms. The proposed solution employs a machine learning approach that learns from user behaviour itself, using previous manual corrections on similar chromatograms to train models, rather than relying solely on mathematical algorithms that cannot capture individual standard operating procedures. This ensemble modelling approach combines the integration tool's outputs with manual corrections mined from histories of manual corrections, using a boosting paradigm to improve results.

### CROSS-REFERENCE TO RELATED APPLICATIONS

This application claims priority to U.S. Provisional Application Ser. No. 63/726,006, entitled “ASSISTING AND AUTOMATING CHROMATOGRAPHIC DATA REVIEW IN NEXT GEN EMPOWER” and filed on Nov. 27, 2024. The contents of the aforementioned application are incorporated herein by reference.

### BACKGROUND

Chromatography is a fundamental analytical technique used extensively in pharmaceutical, chemical, and biological laboratories to separate, identify, and quantify chemical components in complex mixtures. The technique works by passing a sample dissolved in a mobile phase (typically a liquid solvent) through a column packed with a stationary phase material. Different chemical components interact differently with the stationary phase, causing them to travel through the column at different rates and emerge (elution) at different times. As components exit the column, a detector measures their presence, generating an electrical signal that is plotted against time to produce a chromatogram—a visual representation showing peaks corresponding to each separated component.

The process of extracting meaningful analytical information from chromatograms involves two computational steps: peak detection and peak integration. Peak detection involves identifying the locations where chemical components appear in the chromatogram by finding local maxima in the signal. Peak integration involves determining the boundaries of each peak and calculating the area under the curve, which is proportional to the quantity of the component present. For decades, these tasks have been performed by mathematical algorithms that analyse the chromatographic signal and its derivatives. A common approach uses second-derivative analysis, where the algorithm identifies peak locations at points where the second derivative of the signal has local maxima, and determines peak boundaries based on where the first derivative changes sign; these points are used as reference points, to which the algorithm applies heuristics that determines the locations of the boundaries. These algorithms typically employ detection thresholds—numerical cutoff values that distinguish true peaks from background noise based on the magnitude of signal features. The detection thresholds may be default thresholds, but in many cases these default thresholds are not ideal. A user typically will use trial and error to determine the optimal threshold for a given set of chromatograms, increasing the time and complexity of the peak detection and integration process.

Automated peak detection and integration algorithms have become valuable tools in modern analytical laboratories, particularly in high-throughput environments where hundreds or thousands of chromatograms must be processed daily. These algorithms apply consistent mathematical rules to identify peaks and calculate their areas, enabling rapid data processing and reducing the manual effort required from analysts. The algorithms can be configured through processing methods that specify parameters such as detection thresholds, smoothing functions, and baseline definitions—where the baseline represents the portion of the chromatographic signal corresponding to background noise and drift that should be subtracted from the total signal to accurately determine peak area. When properly configured for a given analytical method and sample type, automated algorithms can reliably process routine samples, generating accurate peak identifications and integrations that meet quality standards and regulatory requirements.

Note that, although specific embodiments are described in relation to chromatograms and chromatography, the present invention is not limited only to these examples. The same or very similar techniques can be used in connection with other types of analytical instrument data, including electropherograms, mass spectrograms, and other similar data traces, or the like.

### BRIEF SUMMARY

Exemplary embodiments relate to computer-implemented methods for automated chromatographic peak detection and integration, as well as non-transitory computer-readable mediums storing instructions for performing the methods, apparatuses configured to perform the methods, etc.

The method may include (a) obtaining a training dataset includes: (i) chromatographic data from a plurality of chromatograms, (ii) initial peak detection and integration outputs generated by an analytical integration tool that identifies peak locations in the chromatograms using peak detection parameters, and (iii) manual correction data for the initial peak detection and integration outputs, (b) training a machine learning model using the initial peak detection and integration outputs from the analytical integration tool and the manual correction data, (c) receiving a new chromatogram to be analysed, (d) processing the new chromatogram using the analytical integration tool to generate initial peak detection and integration outputs for the new chromatogram, (e) applying the trained machine learning model to the initial peak detection and integration outputs to generate corrected peak detection and integration outputs, and (f) outputting the corrected peak detection and integration outputs for the new chromatogram.

The computer-implemented method may also include adjusting the peak detection parameters using the machine learning model, the adjusting configured to preserve the initial peak detection and integration outputs when valid, and adjust the initial peak detection and integration outputs when corrections are predicted to be necessary based on user behaviour patterns learned by the machine learning model.

The computer-implemented method may also include automatically categorising the manual correction data using a hierarchical labelling tool that inputs peak attributes from the analytical integration tool and manual correction data, and outputs a hierarchical correction label for each peak.

The analytical integration tool may generate metadata alongside the peak locations, and the machine learning model may be trained using the metadata.

The manual correction may include user-generated modifications to the initial peak detection and integration outputs retrieved from a history of manual corrections.

The machine learning model may be an ensemble machine learning model.

The machine learning model may apply a boosting paradigm in which weak learners includes decision trees are sequentially applied to the initial peak detection and integration outputs, with each decision tree correcting the output of a previous decision tree.

The machine learning model may be trained to reflect site-specific and assay-specific standard operating procedures learned from the manual correction data.

Training the machine learning model may include: identifying candidate peaks by computing second-derivative heights of the chromatograms; labelling the candidate peaks as “true” or “noise” based on the manual correction data; and determining a threshold value separating the true peaks from the noise peaks.

The machine learning model may include a peak boundary model trained to predict start and end times of peaks by learning how reviewers integrate peaks whilst accounting for variance in input signal and variance in reviewer behaviour.

The computer-implemented method may also include receiving a set of reference chromatograms for the given assay; training an anomaly detection model using an Isolation Forest machine learning algorithm; assigning a priority score to each new chromatogram, where the priority score is high for chromatograms that match the reference set and low for anomalous chromatograms that differ from the reference set; and providing a visualisation highlighting specific anomalous peak attributes that contributed to the priority score.

The anomaly detection model may be validated, where the validating includes: selecting a reference set of chromatograms that pass predefined acceptance criteria based on attributes of peaks and column backpressure; and evaluating whether normal chromatograms receive a high score and anomaly chromatograms receive a low score.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a mass spectrometry system.

FIG. 2 illustrates an example of a workflow that operates on acquired data.

FIG. 3A depicts a conventional technique for detecting and integrating peaks.

FIG. 3B illustrates an improved detection and integration technique.

FIG. 4 illustrates an exemplary data flow through a system architecture.

FIG. 5 illustrates an exemplary data structure for storing peak modifications.

FIG. 6 illustrates an exemplary artificial intelligence/machine learning (AI/ML) system.

FIG. 7A depicts an example of aggregated chromatograms suitable for use as training data.

FIG. 7B user corrections to the aggregated chromatograms suitable for use as training data.

FIG. 7C shows an example of how the training data of FIG. 7A and FIG. 7B may be applied to train a machine learning model.

FIG. 8A depicts an exemplary chromatogram with peaks identified by an analytical integration tool.

FIG. 8B depicts the second derivative analysis of the chromatogram of FIG. 8A, including peak locations as identified by the analytical integration tool.

FIG. 8C depicts the original automatically generated chromatogram from the analytical integration tool side-by-side with the user-corrected chromatogram.

FIG. 9A illustrates an example of an automatically integrated chromatogram where peaks have been assigned an exception score based on anomalous peak attributes for a review by exception process.

FIG. 9B depicts an interface showing exception scores for representative peaks.

FIG. 9C depicts an interface showing exception scores for non-representative peaks.

FIG. 10 depicts an illustrative computer system architecture that may be used to practice exemplary embodiments described herein.

### DETAILED DESCRIPTION

Despite the widespread use and general reliability of automated chromatographic peak detection algorithms, significant challenges arise in real-world laboratory environments where analytical conditions are not ideal. Factors such as column ageing, fluidics problems, sub-optimal acquisition methods, poor algorithm parameterisation, and sample preparation issues frequently cause noise, poorly resolved peaks, complicated baselines, and non-Gaussian peak shapes. Under these conditions, mathematical algorithms that rely on idealised assumptions about peak shape and signal characteristics often produce incorrect peak detections or integrations. Noise spikes may be incorrectly identified as true peaks (false positives), genuine peaks may be missed entirely (false negatives), peak boundaries may be incorrectly placed, or overlapping peaks may not be properly resolved. These errors typically require manual review and correction by trained analysts who apply expert judgement and laboratory-specific standard operating procedures to adjust the automated results.

The manual review process is costly, time-consuming, and prone to inconsistency and user error. In pharmaceutical quality control laboratories, analysts may spend hours each day reviewing chromatograms and making manual corrections, representing a significant bottleneck in laboratory workflows and a substantial operational cost. Moreover, different analysts may make different integration decisions for the same chromatogram, leading to inconsistency in results. The challenge is compounded by the fact that “correct” integration often depends on laboratory-specific or method-specific standard operating procedures rather than universal rules. These standard operating procedures may include documented protocols that define how chromatographic data should be processed, integrated, and reviewed to ensure consistency and regulatory compliance, and such protocols often differ between organisations and analytical methods. Interpretations of the procedures may also vary between individual analysts. A single algorithm with fixed parameters cannot capture the nuanced decision-making that experienced analysts apply according to these varied procedures. Traditional approaches to addressing this problem have focused on manually optimising algorithm parameters for each analytical method, but this process is labour-intensive, requires significant expertise, and still fails to capture the full complexity of analyst decision-making patterns.

A problem, therefore, is that mathematical peak detection algorithms cannot learn from or adapt to the specific integration practices and quality standards of individual laboratories, methods, or analysts. There exists an unmet need for a system that can reduce and potentially eliminate analyst review time whilst maintaining or improving the consistency and accuracy of chromatographic peak detection and integration, particularly one that can learn and apply laboratory-specific standard operating procedures automatically rather than relying solely on fixed mathematical rules.

Laboratories also commonly employ standard operating procedures (SOP) to integrate certain challenging peaks in a way that the analytical integration tool cannot always replicate on its own. This means that even after careful parameter configuration, there is often no mathematical way to define the rules that the users employ in their standard operating procedures to manually correct these problems. Oftentimes, a peak will be corrected in a way that maintains consistency with legacy practices, such as where a drop line has always been placed between two peaks with lots of tailing.

### Ensemble Modeling Approach

The described Mathematical and Machine Learning Peak Integration (MMLPI) system is a novel machine learning approach for automatic chromatographic peak detection and integration, reducing or eliminating the need for manual analyst review whilst maintaining consistency and accuracy. Rather than creating a machine learning model that operates on just the raw chromatogram data alone, the MMLPI approach employs an ensemble modelling approach using the outputs of an analytical integration tool (An example of such an analytical integration tool is ApexTrack provided by Waters Corp. of Milford, Massachusetts) combined with a series of machine learning models that are trained on the users' previous manual corrections of the analytical integration tool outputs. This is a novel application of the machine learning boosting paradigm, where weak learners such as decision trees are sequentially applied to data, with each tree correcting the output of the previous, an approach shown to outperform deep learning algorithms on tabular data.

The machine learning approach is able to learn from user behaviour itself, using the previous manual corrections on similar chromatograms to train a machine learning model. This captures customized and often highly differing standard operating procedures of real laboratories and analyses. The machine learning model serves as a correction model to the analytical integration tool algorithm, using raw analytical integration tool output when valid whilst adjusting it when needed.

### Component 1: ML Peak Detection Component

The ML peak detection component optimises and corrects the analytical integration tool to learn laboratory-specific and method-specific integration practices. This component comprises three integrated functions:

### Processing Method Optimisation (Threshold Tuning)

The first function optimises the parameters for the analytical integration tool algorithm by learning the optimal detection threshold, smoothing function parameter, and other parameters to separate “true” from “noise” peaks. The approach involves gathering a training dataset of manually integrated chromatograms for the given assay at set-up, mining users' manual peak detections and corrections, and running analytical integration tool post-processing with non-restrictive thresholds to generate candidate peaks.

### Hierarchical Labelling of Manual Corrections

The second function uses a system of rules to automatically categorise manual integration corrections from the history of manual corrections. The set of rules inputs peak data from both the analytical integration tool and manual integration, then outputs a hierarchical “correction label” per peak. The classification system identifies conceptual edits to a chromatogram that a user might make—such as adding a peak, removing a peak, merging two peaks or separating a peak into two, and modifying the definition of the baseline through more local or more global baseline marks. These features identify the dependent variable values that are the targets of the machine learning models. SOP-Specific ML Correction Models

The third function employs the ensemble modelling approach to create one or more correction models that capture laboratory-specific and method-specific integration practices. The approach extracts properties of the chromatogram, such as first-, second- and third-derivatives, plate count, tailing, and signal-to-noise ratio (SNR). For each of the correction classes identified in the hierarchical labelling, a machine learning model is trained that identifies the user preference for peak detection or integration and applies that correction to the analytical integration tool output.

Models are trained to learn how reviewers integrate smaller peaks, accounting for variance in input signal and variance in reviewer interpretation and application of the SOP, specifically learning to predict the start and end times of peaks. The ensemble approach uses the outputs of the analytical integration tool combined with manual corrections to feed into the machine learning model, which serves as a correction model to the analytical integration tool algorithm.

### Component 2: ML Review by Exception Component

The ML review by exception component assigns a priority score to each chromatogram and provides a boxplot visualisation highlighting specific anomalous peak attributes that contributed to the score. Alternatively or in addition, the review by exception component may make use of probability scores that are generated by the ML models. For example, in the course of normal operation, the ML models may generate scores indicating a certainty of the model in how the model detected and integrated peaks in the chromatogram. This component enables laboratories to focus analyst attention on the chromatograms most likely to require human review, whilst allowing routine chromatograms to proceed without manual intervention.

The user selects a list of “reference” chromatograms for training, and the model assigns a high score for chromatograms that match the reference set. Suspect injections are ranked by a learnt priority score for targeted review based on historical review data, with the model assigning a low score for anomalous chromatograms that differ from the reference set.

When analysing new chromatograms, a visualisation component identifies anomalous peaks and provides a graphical representation (e.g., a boxplot) that helps analysts quickly identify which specific peak attributes (such as unusual retention time, abnormal peak shape, unexpected tailing, or atypical signal-to-noise ratio) contributed to the anomalous classification, enabling more efficient and targeted review.

### Workflow and Deployment

The MMLPI workflow begins with gathering training data, including a training dataset of manually integrated chromatograms and mining the manual corrections. The ML peak detection component first optimises parameters for the analytical integration tool algorithm during processing method optimisation, then executes analytical integration tool integration with the optimised parameters. Additional ML correction models are applied to capture SOP-specific integration characteristics based on the hierarchical labelling of historical corrections.

Following the improved integration, the ML review by exception component applies the learnt anomaly detection model to guide data review and flag suspicious peak attributes. Chromatograms receiving high priority scores proceed without manual review, whilst those with low scores are flagged for analyst attention, with visualisations indicating which specific attributes triggered the anomalous classification.

### Benefits

The MMLPI system transforms the manual, time-consuming data review process into an automated, consistent, and customised system that learns from historical user behaviour whilst maintaining audit-friendly traceability. The approach is particularly valuable in pharmaceutical quality control laboratories where standard operating procedures dictate specific integration practices, and where consistency, traceability, and compliance with regulatory requirements are important.

The system addresses common challenges in chromatographic analysis, including column age, fluidics problems, sub-optimal acquisition methods, poor analytical integration tool parameterisation, and sample preparation issues that cause noise, poorly resolved peaks, complicated baselines, and non-Gaussian peak shapes. By learning from the historical data, the system can automatically apply laboratory-specific practices for handling these challenging conditions, reducing false positives and false negatives whilst improving consistency across analysts and over time.

The MMLPI system also produces more consistent results from user-to-user or analysis-to-analysis within a given lab, and ensures a more rigorous, objective application of lab SOPs. Moreover, when new SOPs are adopted by the lab over time, the ML models underlying the MMLPI system can be easily and quickly retrained to adapt to changing standards.

### Technical Advantages

The ensemble approach offers several technical advantages over alternative approaches such as deep learning on raw chromatogram data. By using analytical integration tool outputs as inputs to the machine learning model rather than replacing the analytical integration tool entirely, the system preserves the mathematical rigour and interpretability of the existing algorithm whilst adding the flexibility to learn from user behaviour. This approach is more robust to variations in analytical conditions and requires less training data than deep learning approaches, whilst providing better interpretability for regulatory compliance.

The boosting paradigm, where weak learners such as decision trees are sequentially applied with each correcting the previous, has been shown to outperform deep learning algorithms on tabular data. The probabilistic Bayesian approach for peak detection and integration parameter optimisation provides uncertainty quantification, enabling more informed decision-making and better identification of cases requiring human review.

The combination of the ML peak detection component and the ML review by exception component creates a comprehensive solution that both improves the quality of automated integration and reduces the burden of manual review. This two-component architecture represents a paradigm shift in chromatographic data analysis, moving from fixed mathematical algorithms to adaptive machine learning systems that learn from and apply laboratory-specific standard operating procedures automatically, reducing analyst workload whilst maintaining or improving data quality and regulatory compliance.

The described technology solves the technical problem that mathematical peak detection algorithms cannot adequately handle real-world analytical conditions such as column ageing, fluidics problems, sub-optimal acquisition methods, poor algorithm parameterisation, and sample preparation issues that cause noise, poorly resolved peaks, complicated baselines, and non-Gaussian peak shapes. The MMLPI solution provides a concrete solution to the costly, time-consuming manual review process that is prone to inconsistency and user error by using an ensemble machine learning approach to learn a custom-tailored integration algorithm for each site and assay based historic manual integration corrections for similar chromatograms.

The solution employs an unconventional ensemble modelling approach that uses the outputs of an analytical integration tool combined with manual corrections mined from the history of manual corrections to create correction models. This approach represents a novel application of the machine learning boosting paradigm, where weak learners such as decision trees are sequentially applied to data with each tree correcting the output of the previous, a technique that has been shown to outperform deep learning algorithms on tabular data. Rather than discarding the valuable information provided by the analytical integration tool (such as peak shapes, locations, widths, baseline behaviour, plate count, and resolution calculations) and creating models that operate on raw chromatogram data alone, the ensemble approach uses the analytical integration tool outputs as a foundation and trains models to apply corrections when needed. This unconventional combination of existing analytical integration tool outputs with machine learning correction models represents significantly more than merely applying generic computer technology to an abstract idea.

The MMLPI system provides specific technological improvements to the functioning of chromatographic data processing systems by automatically learning optimised parameters for the analytical integration tool algorithm, training additional ML correction models to capture SOP-specific integration characteristics, and learning an anomaly detection model to guide data review and flag suspicious peak attributes after an improved integration. The training and application workflow happens post-deployment, on site, using the analyst's own historical data, enabling the system to adapt to laboratory-specific conditions and standard operating procedures in a manner that conventional mathematical algorithms cannot achieve. In a challenging dataset from an external collaborator, the MMLPIsystem decreased the number of false peaks by 86%, the number of missed peaks by 41%, and reduced the error in the total peak integration area by 67% compared to the existing processing method developed by the laboratory, demonstrating concrete improvements in the technical field of chromatographic analysis.

The solution further includes unconventional steps such as the development of a set of rules to automatically categorise manual integration corrections from the history of manual corrections, which inputs peak data from both the analytical integration tool and manual integration, then outputs a hierarchical “correction label” per peak that is used to train a network of custom-tailored, SOP-specific ML integration correction models for a given site and assay. The hierarchical classification system identifies conceptual edits to a chromatogram that a user might make—such as adding a peak, removing a peak, merging two peaks or separating a peak into two, and modifying the definition of the baseline through more local or more global baseline marks. This hierarchical labelling approach represents an unconventional preprocessing step that enables the machine learning models to learn specific types of corrections that analysts make, going beyond generic data classification.

### Applications

The (ADR) system was originally designed for in pharmaceutical and biopharmaceutical analytical development and quality control laboratories where liquid chromatography (LC) is employed for routine analytical testing. The primary context is high-throughput environments where analysts must review hundreds or thousands of chromatograms daily, such as in column packing quality control, drug substance release testing, stability studies, and impurity profiling.

The typical use case involves pharmaceutical laboratories where standard operating procedures (SOPs) dictate specific integration practices, and where consistency, traceability, and compliance with regulatory requirements are paramount. The system is particularly valuable in scenarios where column age, fluidics problems, sub-optimal acquisition methods, poor ApexTrack parameterisation, and sample preparation issues cause noise, poorly resolved peaks, complicated baselines, and non-Gaussian peak shapes that lead to incorrect peak detection or integration.

Nonetheless, the described techniques can be applied in many other applications as well. For example, an ensemble machine learning approach that learns from user behaviour could be applied to gas chromatography or electropherograms, where similar challenges exist with peak detection in complex matrices, overlapping peaks, and baseline drift. The same methodology of mining histories of manual corrections to learn site-specific and method-specific integration preferences would be equally valuable in GC laboratories performing environmental analysis, petrochemical testing, or food safety analysis.

The labelling approach and anomaly detection could be extended to two-dimensional Chromatography (2D-LC or GCxGC) where the complexity of peak patterns increases exponentially. The ML models could learn to identify and integrate peaks in 2D space, accounting for co-elution patterns and modulation effects that are difficult to capture with traditional algorithms.

The probabilistic parameter optimisation using Bayesian optimization in the form of Gaussian processes could be applied to mass spectrometry peak detection, where determining the boundary between signal and noise is equally challenging. The system could learn from how analysts integrate mass spectral peaks, particularly in complex biological matrices where matrix effects and ion suppression create variable baselines.

The hierarchical classification system that categorises peaks as Added, Deleted, Merged, or Split could be enhanced to automatically detect and characterise unknown impurities or degradation products in stability studies. The system could learn patterns of how impurities evolve over time and flag unexpected peaks for further investigation.

The peak boundary models that learn how reviewers integrate smaller peaks whilst accounting for variance in input signal could be particularly valuable for chiral Chromatography, where enantiomeric peaks often have subtle differences in retention time and may be poorly resolved. The system could learn laboratory-specific practices for integrating chiral peaks and calculating enantiomeric excess.

In addition to chemistry analyses, the general concept of using ensemble machine learning to learn from expert corrections to improve automated analysis has broad applicability beyond chromatography.

In manufacturing environments with automated optical inspection systems, human inspectors routinely override automated defect detection decisions. The hierarchical labelling approach could categorise inspector corrections (false positive rejection, missed defect addition, defect reclassification), and ensemble models could learn factory-specific and product-specific quality standards. The anomaly detection component could flag products that deviate from reference standards for targeted human review.

In fraud detection and anti-money laundering systems, compliance analysts regularly review and correct automated transaction flagging systems. The ensemble learning approach could mine histories of manual corrections of analyst decisions to learn institution-specific risk tolerance and regulatory interpretation, creating models that reduce false positives whilst maintaining sensitivity to genuine suspicious activity. The Bayesian threshold optimisation could be applied to determine optimal risk scores for flagging transactions.

In bioinformatics, analysts frequently correct automated gene calling, variant calling, and sequence alignment algorithms. The ensemble approach could learn from curator corrections in genomic databases to improve automated annotation, particularly for difficult regions with repetitive sequences or structural variations. The probabilistic threshold model could optimise quality score thresholds for variant calling based on laboratory-specific validation data.

In industrial equipment monitoring, maintenance engineers override automated failure prediction systems based on contextual knowledge. The system could learn from maintenance logs and work orders to understand when automated alerts should be adjusted based on equipment history, operating conditions, or planned maintenance schedules.

These represent but a few example applications of the described technology. The technology's applicability across these diverse fields stems from several principles:
1. Human-in-the-Loop Learning: Many automated systems benefit from human expertise but struggle to capture tacit knowledge and context-specific decision-making that experts apply when correcting automated outputs.
2. Historic Manual Correction Mining: Any system that records human corrections to automated decisions creates a valuable training dataset that captures expert behaviour and domain-specific practices.
3. Ensemble Correction Rather Than Replacement: The approach of using ML as a correction model to existing algorithms, preserving valid outputs whilst adjusting when needed, is more robust and interpretable than complete replacement with black-box deep learning.
4. Site-Specific and Context-Specific Customisation: The ability to learn organisation-specific, method-specific, or user-specific practices from historical data addresses the reality that “correct” decisions often depend on local standards, regulatory interpretations, or risk tolerance rather than universal ground truth.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided.

### Exemplary Embodiments

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

These and other features will be described in more detail below with reference to the accompanying figures.

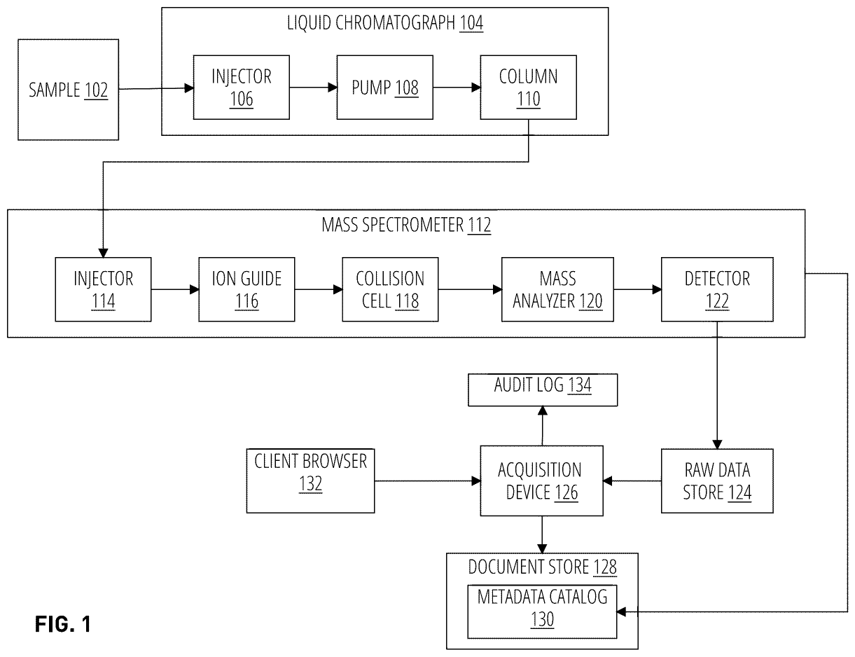

For purposes of illustration, FIG. 1 is a schematic diagram of a system that may be used in connection with techniques herein. Although FIG. 1 depicts particular types of devices in a specific LCMS configuration, one of ordinary skill in the art will understand that different types of chromatographic devices may also be used in connection with the present disclosure.

A sample 102 is injected into a liquid chromatograph 104 through an injector 106. A pump 108 pumps the sample through a column 110 to separate the mixture into component parts according to retention time through the column.

The output from the column is input to a mass spectrometer 112 for analysis. Initially, the sample is dissolved and ionized by a desolvation/ionization device 114. Desolvation can be any technique for desolvation, including, for example, a heater, a gas, a heater in combination with a gas or other desolvation technique. Ionization can be by any ionization techniques, including for example, electrospray ionization (ESI), atmospheric pressure chemical ionization (APCI), matrix assisted laser desorption (MALDI) or other ionization technique. Ions resulting from the ionization are fed to a collision cell 118 by a voltage gradient being applied to an ion guide 116. Collision cell 118 can be used to pass the ions (low-energy) or to fragment the ions (high-energy).

Different techniques (including one described in U.S. Pat. No. 6,717,130, to Bateman et al., which is incorporated by reference herein) may be used in which an alternating voltage can be applied across the collision cell 118 to cause fragmentation. Spectra are collected for the precursors at low-energy (no collisions) and fragments at high-energy (results of collisions).

The output of collision cell 118 is input to a mass analyzer 120. Mass analyzer 120 can be any mass analyzer, including quadrupole, time-of-flight (TOF), ion trap, magnetic sector mass analyzers as well as combinations thereof. A detector 122 detects ions emanating from mass analyzer 122. Detector 122 can be integral with mass analyzer 120. For example, in the case of a TOF mass analyzer, detector 122 can be a microchannel plate detector that counts intensity of ions, i.e., counts numbers of ions impinging it.

A raw data store 124 may provide permanent storage for storing the ion counts for analysis. For example, raw data store 124 can be an internal or external computer data storage device such as a disk, flash-based storage, and the like. An acquisition 126 analyzes the stored data. Data can also be analyzed in real time without requiring storage in a storage medium 124. In real time analysis, detector 122 passes data to be analyzed directly to computer 126 without first storing it to permanent storage.

Collision cell 118 performs fragmentation of the precursor ions. Fragmentation can be used to determine the primary sequence of a peptide and subsequently lead to the identity of the originating protein. Collision cell 118 includes a gas such as helium, argon, nitrogen, air, or methane. When a charged precursor interacts with gas atoms, the resulting collisions can fragment the precursor by breaking it up into resulting fragment ions.

Different suitable methods may be used with a system as described herein to obtain ion information such as for precursor and product ions in connection with mass spectrometry for an analyzed sample. The data acquired allows for the accurate determination of the retention times, mass-to-charge ratios, and intensities of all ions collected in both low- and high-energy modes. In general, different ions are seen in the two different modes, and the spectra acquired in each mode may then be further analyzed separately or in combination. The ions from a common precursor as seen in one or both modes will share the same retention times (and thus have substantially the same scan times) and peak shapes. The high-low protocol allows the meaningful comparison of different characteristics of the ions within a single mode and between modes. This comparison can then be used to group ions seen in both low-energy and high-energy spectra.

In summary, a sample 102 is injected into the LC/MS system. The LC/MS system produces two sets of spectra, a set of low-energy spectra and a set of high-energy spectra. The set of low-energy spectra contain primarily ions associated with precursors. The set of high-energy spectra contain primarily ions associated with fragments. These spectra are stored in a raw data store 124. After data acquisition, these spectra can be extracted from the raw data store 124 and displayed and processed by post-acquisition algorithms in the acquisition 126.

Metadata describing various parameters related to data acquisition may be generated alongside the raw data. This information may include a configuration of the liquid chromatograph 104 or mass spectrometer 112 (or other chromatography apparatus that acquires the data), which may define a data type. An identifier (e.g., a key) for a codec that is configured to decode the data may also be stored as part of the metadata and/or with the raw data. The metadata may be stored in a metadata catalog 130 in a document store 128.

The acquisition 126 and/or subsequent analysis of the data may operate according to a workflow, providing visualizations of data to an analyst at each of the workflow steps and allowing the analyst to generate output data by performing processing specific to the workflow step. The workflow may be generated and retrieved via a client browser 132. As the acquisition 126 performs the steps of the workflow, it may read raw data from a stream of data located in the raw data store 124. As the acquisition 126 performs the steps of the workflow, it may generate processed data that is stored in a metadata catalog 130 in a document store 128; alternatively or in addition, the processed data may be stored in a different location specified by a user of the acquisition 126. It may also generate audit records that may be stored in an audit log 134.

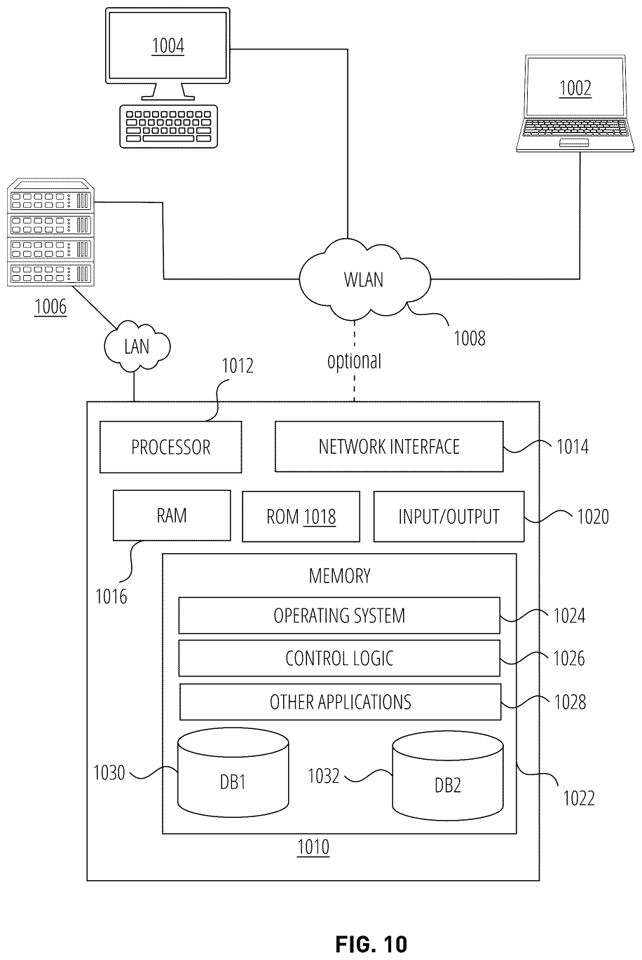

The exemplary embodiments described herein may be performed at the client browser 132 and acquisition 126, among other locations. An example of a device suitable for use as an acquisition 126 and/or client browser 132, as well as various data storage devices, is depicted in FIG. 10.

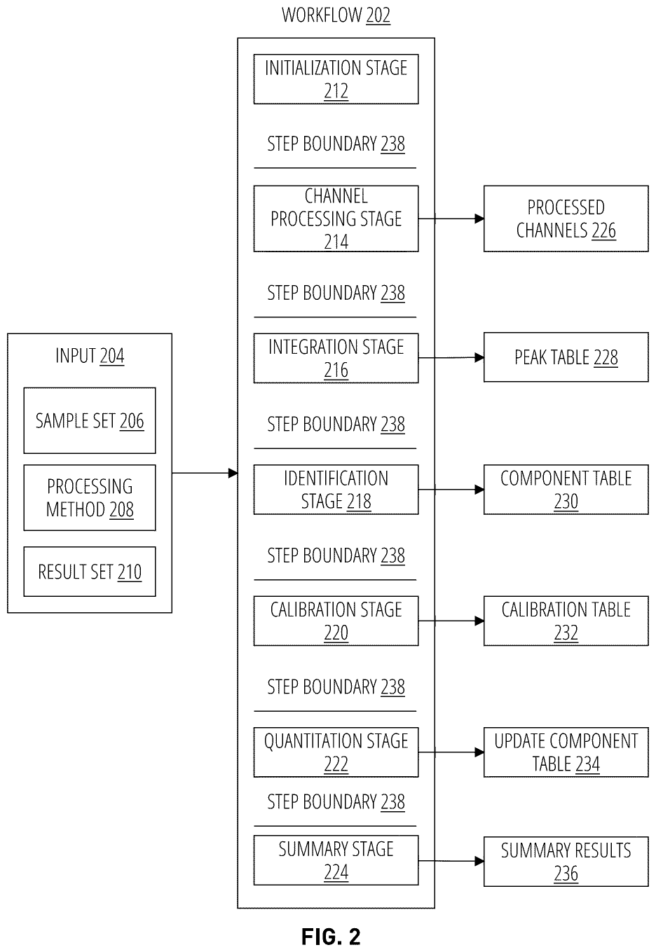

For context, FIG. 2 depicts a simplified example of a workflow 202 that may be applied by the acquisition 126 of FIG. 1. The workflow 202 is designed to take a set of inputs 204, apply a number of workflow steps or stages to the inputs to generate outputs at each stage, and continue to process the outputs at subsequent stages in order to generate results of the experiment. It is noted that the workflow 202 is a specific example of a workflow, and includes particular stages performed in a particular order. However, the present invention is not limited to the specific workflow depicted in FIG. 2. Other suitable workflows may have more, fewer, or different stages performed in different orders. Some or all of the workflow steps may be performed by an analytical integration tool, such as Apex Track.

The initial set of inputs 204 may include a sample set 206, which includes the raw (unprocessed) data received from the Chromatography experimental apparatus. This may include measurements or readings, such as mass-to-charge ratios. The measurements that are initially present in the sample set 206 may be measurements that have not been processed, for example to perform peak detection or other analysis techniques. The sample set 206 may include data in the form of a stream (e.g., a sequential list of data values received in a steady, continuous flow from an experimental apparatus).

In the context of the present application, the sample set 206 may represent the raw data stored in the raw data store 124 and returned by the endpoint interface. The sample set 206 may be represented as a model of a data stream (e.g., including data structures corresponding to data points gathered by the chromatography apparatus). The workflow 202 may be performed on the sample set 206 data by an application running on the acquisition 126 and/or running within a data ecosystem.

The initial set of inputs 204 may also include a processing method 208, which may be a template method (as discussed above) that is applied to (and hence embedded in) the workflow 202. The processing method 208 may include settings to be applied at various stages of the workflow 202.

The initial set of inputs 204 may also include a result set 210. When created, the result set 210 may include the information from the sample set 206. In some cases, the sample set 206 may be processed in some initial manner when copied into the result set 210—for example, MS data may require extracting, smoothing, etc. before being provided to a workflow 202. The processing applied to the initial result set 210 may be determined on a case-by-case basis based on the workflow 202 being used. Once the raw data is copied from a sample set 206 to create a result set 210, that result set 210 may be entirely independent from the sample set 206 for the remainder of its lifecycle.

The workflow 202 may be divided into a set of stages. Each stage may be associated with one or more stage processors that perform calculations related to that stage. Each stage processor may be associated with stage settings that affect how the processor generates output from a given input.

Stages may be separated from each other by step boundaries 238. The step boundaries 238 may represent points at which outputs have been generated by a stage and stored in the result set, at which point processing may proceed to the next stage. Some stage boundaries may require certain types of input in order to be crossed (for example, the data generated at a given stage might need to be reviewed by one or more reviewers, who need to provide their authorization in order to cross the step boundary 238 to the next stage). Step boundaries 238 may apply any time a user moves from one stage to a different stage, in any direction. For example, a step boundary 238 exists when a user moves from the initialization stage 212 to the channel processing stage 214, but also exists when a user attempts to move backwards from the quantitation stage 222 back to the integration stage 216. Step boundaries 238 may be ungated, meaning that once a user determines to move to the next stage no further input (or only a cursory input) is required, or gated, meaning that the user must provide some sort of confirmation indicating that they wish to proceed to a selected stage (perhaps in response to a warning raised by the acquisition 126), or a reason for moving to a stage, or credentials authorizing the workflow 202 to proceed to the selected stage.

In an initialization stage 212, each of the stage processors may respond by clearing the results that it generates. For example, the stage processor for the channel processing stage 214 may clear all its derived channels and peak tables (see below). At any point in time, clearing a stage setting may clear stage tracking from the current stage and any subsequent stage. In this example, the initialization stage 212 does not generate any output.

After crossing a step boundary 238, processing may proceed to a channel processing stage 214. As noted above, chromatography detectors may be associated with one or more channels on which data may be collected. At the channel processing stage 214, the acquisition 126 may derive a set of processing channels present in the data in the result set 210, and may output a list of processed channels 226. The list of processed channels 226 may be stored in a versioned sub-document associated with the channel processing stage 214, which may be included in the result set 210.

After crossing a step boundary 238, processing may proceed to an integration stage 216, which identifies peaks in the data in the result set 210 based on the list of processed channels 226. The integration stage 216 may identify the peaks using techniques specified in the settings for the integration stage 216, which may be defined in the processing method 208. The integration stage 216 may output a peak table 228 and store the peak table 228 in a versioned sub-document associated with the integration stage 216. The sub-document may be included in the result set 210.

After crossing a step boundary 238, processing may proceed to identification stage 218. In this stage, the acquisition 126 may identify components in the mixture analyzed by the chromatography apparatus based on the information in the peak table 228. The identification stage 218 may output a component table 230, which includes a list of components present in the mixture. The component table 230 may be stored in a versioned sub-document associated with the identification stage 218. The sub-document may be included in the result set 210.

After crossing a step boundary 238, processing may proceed to calibration stage 220. During a chromatography experiment, calibration compounds may be injected into the chromatography apparatus. This process allows an analyst to account for subtle changes in electronics, cleanliness of surfaces, ambient conditions in the lab, etc. throughout an experiment. In the calibration stage 220, data obtained with respect to these calibration compounds is analyzed and used to generate a calibration table 232, which allows the acquisition 126 to make corrections to the data to ensure that it is reliable and reproducible. The calibration table 232 may be stored in a versioned sub-document associated with the calibration stage 220. The sub-document may be included in the result set 210.

After crossing a step boundary 238, processing may proceed to quantitation stage 222. Quantitation refers to the process of determining a numerical value for the quantity of an analyte in a sample. The acquisition 126 may use the results from the previous stages in order to quantify the components included in the component table 230. The quantitation stage 222 may update 234 the component table 230 stored in the result set 210 with the results of quantitation. The updated component table 230 may be stored in a versioned sub-document associated with the quantitation stage 222. The sub-document may be included in the result set 210.

After crossing a step boundary 238, processing may proceed to summary stage 224. In the summary stage 224, the results of each of the previous stages may be analyzed and incorporated into a report of summary results 236. The summary results 236 may be stored in a versioned sub-document associated with the summary stage 224. The sub-document maybe included in the result set 210.

As used herein, a step may correspond to the above-noted stages. Alternatively, a single stage may include multiple steps, or multiple stages may be organized into a single step. In any event, all the activities performed in a given step should be performable by the same user or group of users, and each step is associated with one or more pages that describe a set of configuration options for the step (e.g., visualization options, review options, step configuration settings, etc.)

There may be a transition at some or all of the step boundaries 238, although not every step boundary 238 need be a transition. A transition may signify a change in responsibility for a set of data from a first user or group of users to a second, distinct user or group of users.

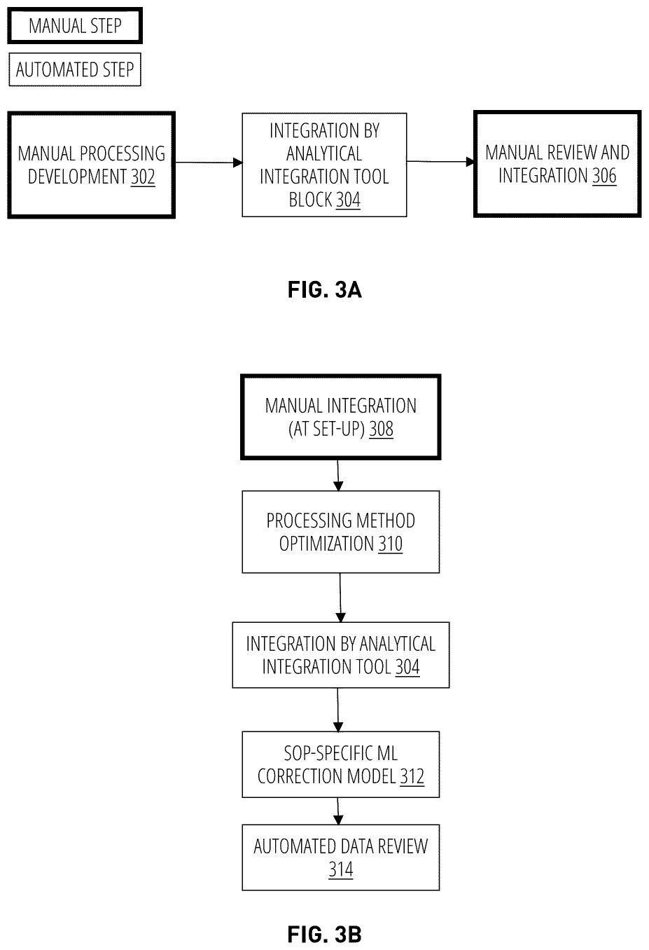

FIG. 3A illustrates a conventional workflow for chromatographic data processing that relies heavily on manual intervention. The workflow begins with a manual processing development block 302, where analysts develop and configure processing parameters. This manual parameter configuration process is time-consuming and requires significant expertise.

The manual processing method development step involves configuring parameters for the analytical integration tool, which uses a “Detection Threshold” that detects peaks based on minimum height in the second derivative and a “Peak Width” that is a characteristic length used in a smoothing function for the chromatogram prior to peak detection. The analyst must manually determine appropriate values for these and potentially other parameters that control how the analytical integration tool identifies and integrates peaks in chromatograms.

The chosen algorithm parameters might not be optimal for a given assay, resulting in poor separation of peaks in the chromatogram, and ultimately poor peak detection, characterization and integration. The analyst typically selects detection threshold, peak width, minimum area, minimum height, liftoff percentage, and touchdown percentage that control how peak boundaries are determined and areas are calculated, tests and refines the parameters by processing sample chromatograms with the chosen parameters, reviewing the results, and iteratively adjusting the parameters until acceptable peak detection and integration is achieved for the specific assay, and balances sensitivity and specificity by determining parameter values that detect genuine peaks whilst avoiding false positives from noise, a process that requires expert judgement about the expected characteristics of the sample.

Laboratories also commonly employ standard operating procedures (SOP) to integrate certain challenging peaks in a way that the analytical integration tool cannot always replicate on its own. This means that even after careful parameter configuration, there is often no mathematical way to define the rules that the users employ in their standard operating procedures to manually correct these problems. Oftentimes, a peak will be corrected in a way that maintains consistency with legacy practices, such as where a drop line has always been placed between two peaks with lots of tailing.

For this reason, the analytical integration tool are not expressive enough to capture the individual and often highly differing standard operating procedures of the users in real labs. The manual processing method development 302 shown in FIG. 3A therefore represents a labour-intensive process that requires significant analyst expertise and time, yet still may not capture the full complexity of laboratory-specific integration practices. This review process is costly, time-consuming, and prone to inconsistency and user error, which is the fundamental problem that the Mathematical and Machine Learning Peak Integration system addresses.

Following this manual setup, integration by analytical integration tool block 304 performs automated peak detection and integration using the configured parameters. Block 304 may be performed by an analytical integration tool.

However, the workflow then requires manual review and integration block 306, where trained analysts must review the automated results and make corrections based on their expert judgement and laboratory-specific standard operating procedures.

Thus, the conventional approach shown in FIG. 3A relies on manual effort both in the initial setup and in ongoing review of each chromatogram.

FIG. 3B illustrates the improved workflow enabled by the Mathematical and Machine Learning Peak Integration (EMMLCPI) system, which substantially reduces or eliminates the need for manual intervention whilst maintaining or improving data quality.

The workflow begins with manual integration (at set-up) block 308, where analysts manually correct a training dataset of chromatograms integrated by the analytical integration tool for the given assay or assays during initial system configuration. Initially, a user may create a processing method as in the previous example from FIG. 3A, but may simply opt to use the default values for all the parameters. Consequently, the initial manual setup is much simpler. The ML pipeline can then be relied upon to optimize the detections and integrations. This training data is then used in processing method optimisation block 310, where machine learning algorithms learn the optimal detection thresholds and parameters by analysing the manual integration patterns mined from the history of manual corrections. The training and use of these machine learning algorithms will be discussed in more detail below.

Following optimisation, integration by analytical integration tool block 304 performs peak detection and integration using the learnt parameters in a similar manner as was done in FIG. 3A.

The output from the analytical integration tool is then processed by a SOP-specific ML correction model block 312, which applies laboratory-specific and method-specific corrections based on patterns learnt from historical analyst behaviour. The training and use of this model is discussed in more detail below.

Finally, automated data review block 314 applies anomaly detection to identify chromatograms requiring human attention whilst allowing routine chromatograms to proceed without manual review.

Unlike the conventional workflow shown in FIG. 3A, this improved workflow uses a reduced amount of manual effort only during initial set-up, with all subsequent chromatograms processed automatically using the learnt correction models and standard operating procedures.

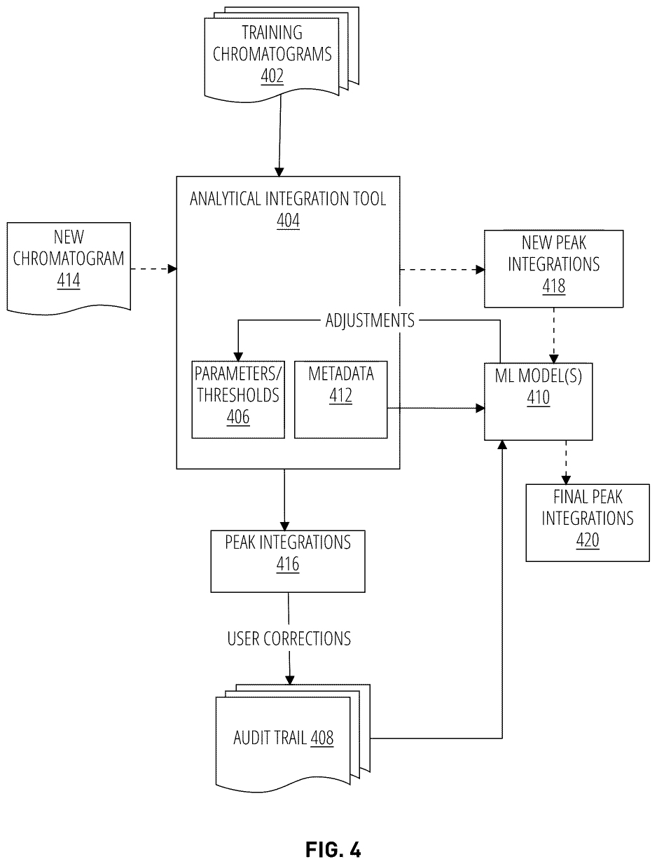

The actions described in FIG. 3B may be embodied as logic for performing a computer-implemented method according to an exemplary embodiment. The logic may be embodied as instructions stored on a non-transitory computer-readable medium configured to be executed by a processor. The logic may be implemented by a suitable computing system configured to perform the actions described above (and below with respect to FIG. 4 and the remaining Figures).

FIG. 4 illustrates the overall architecture and data flow of the Mathematical and Machine Learning Peak Integration system, showing how training chromatograms 402 and user corrections from history of manual corrections 408 are used to train ML model(s) 410 that improve peak detection and integration.

The system begins with training chromatograms 402, which represent a collection of previously acquired chromatographic data for a specific assay that have been manually integrated by trained analysts. These training chromatograms 402 serve as the foundation for the machine learning approach, providing examples of how analysts have historically handled various peak detection and integration challenges, including noise, poorly resolved peaks, complicated baselines, and non-Gaussian peak shapes that conventional processing tools alone cannot adequately address. The training chromatograms 402 are selected from the laboratory's historical data and represent the range of conditions and sample types that the system will encounter during routine operation. This training process happens post-deployment, on site, using the analyst's own historical data, ensuring that the models learn laboratory-specific and method-specific integration practices.

These training chromatograms 402 are processed by analytical integration tool 404 using parameters/thresholds 406, which represent the initial configuration settings for the peak detection process. The analytical integration tool 404 implements processing techniques for peak detection, boundary setting, and integration. For example, the analytical integration tool 404 may determine peak locations by identifying points where the chromatogram's second derivative has a local minimum and determines peak boundaries as a heuristic function of the location where the second derivative changes sign. The parameters/thresholds 406 include settings such as the detection threshold (which specifies the minimum height in the second derivative required to identify a peak), peak width, minimum area and height requirements, and baseline definition parameters. These parameters may initially be set to non-restrictive values to ensure that all potential peaks are detected, allowing the machine learning models to subsequently learn which detections represent true peaks versus noise.

The analytical integration tool 404 generates initial peak integrations 416, which represent the automated peak detection and integration results produced by the processing tool using the original parameters/thresholds 406. These peak integrations 416 may, for example, comprise a peak table containing attributes for each detected peak, including peak location (retention time), peak height, peak area, peak width, start time, end time, baseline definition, signal-to-noise ratio, tailing factor, plate count, and other chromatographic properties. For well-behaved chromatograms where peaks are well resolved and shapes are Gaussian, these automated integrations are very successful, but factors such as column age, fluidics problems in the instrument, sub-optimal acquisition methods, sub-optimal parameter settings, and issues with sample preparation can cause the automated tool to incorrectly detect peaks (missing genuine peaks or identifying noise as peaks) or incorrectly integrate peaks (determining wrong peak extents or poorly specifying boundaries between consecutive peaks).

The peak integrations 416 are then manually corrected by a user, with the corrections stored in a history of manual corrections 408. The history of manual corrections 408 is a comprehensive record maintained by a chromatography data system (such as the Empower system provided by Waters Corp. Of Milford, Massachusetts) that logs all manual modifications made to peak integrations, including when peaks were added, deleted, merged, split, renamed, or had their boundaries adjusted. The history of manual corrections 408 is mined to retrieve users' manual peak detections and corrections, providing a rich source of training data that captures analyst behaviour and laboratory-specific standard operating procedures. These user corrections represent human decisions rather than definitive truths, often maintaining consistency with legacy practices, such as where a drop line has always been placed between two peaks with significant tailing, capturing integration rules that cannot be precisely defined but are essential to the laboratory's standard operating procedures.

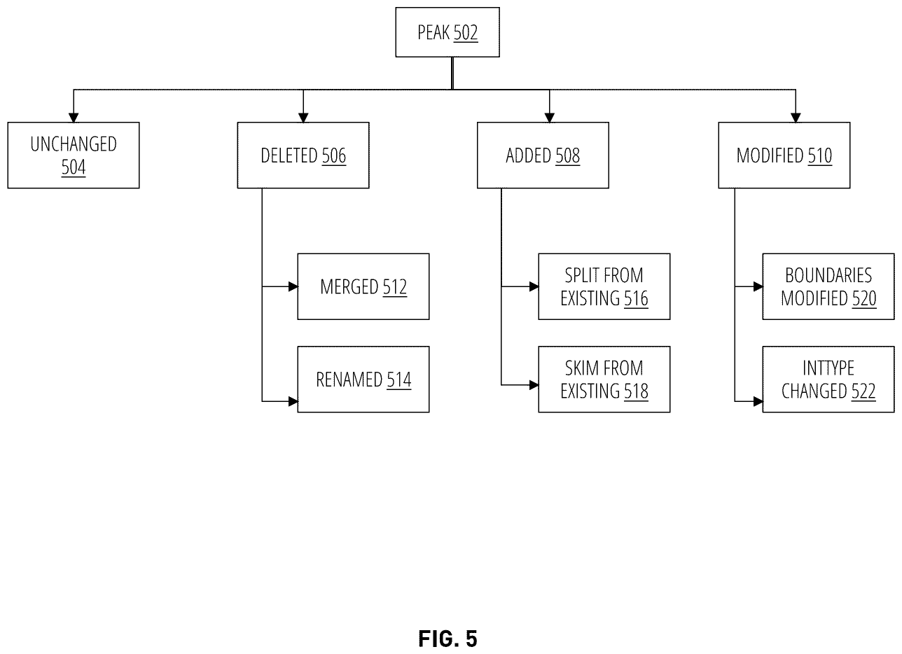

In some embodiments, the corrections in the history of manual corrections 408 may be automatically categorized with a hierarchical data structure, as discussed in more detail in connection with FIG. 5.

Along with the peak integrations and user corrections, the system also utilises metadata 412, which describes chromatogram properties and contextual information about each sample. The metadata 412 includes calculated peak features of the chromatogram such as the first-, second-, and third-derivative calculations made by the analytical integration tool, plate count, tailing factor, signal-to-noise ratio, resolution between peaks, baseline characteristics, and other quality metrics that provide context for understanding why certain manual corrections were made. The metadata may also include information about variations in analytical conditions such as the specific LC system used (to account for variations in signal-to-noise across distinct instruments), column age, injection count, and other factors that influence chromatographic behaviour. This contextual information enables the machine learning models to learn not just what corrections were made, but under what conditions those corrections are appropriate.

These inputs—peak integrations 416, user corrections from history of manual corrections 408, and metadata 412—are used to train ML model(s) 410, which employ an ensemble modelling approach that uses the outputs of the analytical integration tool combined with manual corrections mined from the history of manual corrections to create correction models. Rather than discarding the valuable information provided by the analytical integration tool (such as peak shapes, locations, widths, baseline behaviour, plate count, and resolution calculations) and creating models that operate on raw chromatogram data alone, the ensemble approach uses the analytical integration tool outputs (including the metadata 412) as a foundation and trains models to apply corrections when needed. This approach represents a novel application of the machine learning boosting paradigm, where weak learners such as decision trees are sequentially applied to data with each tree correcting the output of the previous, a technique that has been shown to outperform deep learning on tabular data. The ML model(s) 410 learn a custom-tailored integration process based on reviewer history, capturing the specific integration practices and standard operating procedures of the individual laboratory and assay.

The ML models 410 of FIG. 4 can include a model that updates the analytical integration tool's 404 parameters and thresholds 406, which allows the tool to identify peaks in a manner more consistent with laboratory SOPs. They can also include post-processing correction models, which allow the system to perform tasks that the analytical integration tool 404 cannot (e.g., because it was not designed to perform those tasks). This can add capabilities like: integrating multiple peaks as a single peak (for example, when impurities are clustered together and the analyst is only interested in the total amount of impurities rather than the amount of each individual impurity); and identifying when a peak is missing in individual chromatograms in a series, where the peak is present in other chromatograms in the series (thus allowing a valley in the chromatogram to be identified as a peak).

The ML models 410 in FIG. 4 serve two distinct but complementary functions: first, they learn optimised parameters 406 for the analytical integration tool 404, and second, they train additional ML correction models to capture SOP-specific integration characteristics. These two categories of models work together to provide a comprehensive automated data review solution that addresses both the limitations of the analytical integration tool's 404 configuration and the need for laboratory-specific customisation that extends beyond the tool's designed capabilities.

The first category of ML models 410 focuses on optimising the analytical integration tool's 404 parameters 406 by using a Bayesian model that takes analytical integration tool 404 outputs and user corrections from the history of manual corrections 408 as inputs to determine optimal parameters to achieve better peak detections. Specifically, the detection threshold parameter controls peak detection based on the magnitude of local maxima in the second derivative, and candidate peaks are labelled as “True” or “Noise” based on users' manual integration mined from the history of manual corrections 408. Rather than relying on manually developed parameters, the system discovers the optimal value for detection threshold and peak width based on results histories and users' manual corrections, creating a probabilistic model to determine the peak width and detection threshold combination that optimally distinguishes between “True” and “Noise” peaks, where the search space is constrained to a neighborhood of the existing analytical integration tool 404 “auto” detection threshold and “auto” peak width functions.

The analytical integration tool determines peak location by computing second-derivative heights, identifying points where the chromatogram's second derivative has a local minimum. The peak width may be used as the width of a smoothing filter to remove noise when computing the second derivative. Candidate peaks are labelled as “True” or “Noise” based on users' manual integration mined from the history of manual corrections. A Gaussian Process model is then trained to learn the optimal detection threshold and peak width to separate true and noise peaks.

In more detail, the system employs a Bayesian optimization loop utilizing a Gaussian process surrogate model for the objective function. The optimization process comprises an iterative workflow wherein chromatograms are integrated with specific peak width and detection threshold parameters, the results are labeled against ground-truth integration from a reviewer, precision and recall are computed from the labels, an objective function value is computed from precision and recall, a model is built to predict the objective function value from analytical integration tool parameters, and new parameters are chosen to minimize the objective function model.

The objective function is designed to maximize detection of true peaks (recall) while minimizing detection of false peaks (precision), creating a function that is low when recall and precision are low and high when they are high. In this scenario, Recall is defined as the number of peaks detected correctly divided by the total number of true peaks, and Precision is defined as the number of peaks detected correctly divided by the total number of peaks detected. For the purposes of peak detection in a noisy solution that may contain critical impurity peaks near the noise floor, the recall is a more important metric. For this reason, the system employs a biased objective function that prioritizes recall over precision without changing the optimal value. For example, a “balanced” objective function would return the same value when recall equals 0.9 and precision equals 0.2 as when recall equals 0.2 and precision equals 0.9. treating missing peaks and false peaks equally, which in effect can lead to missing peaks. A “biased” objective function maintains the same overall optimal values but weights missing peaks more heavily than false peaks. A recall of 0.2 and precision of 0.9 would give a higher objective function value than a recall of 0.9 and precision of 0.2, so the algorithm favors high recall, leading to fewer missing peaks.

In exemplary embodiments, the model employs an objective function comprising the sum of one minus recall for the smallest ten percent of peaks by percent area plus the squared term for one minus precision, plus a penalty term for large parameter values defined as a regularization constant multiplied by the ratio of distance to the smallest parameters in the search space divided by the maximum distance in the search space, wherein the search space for peak width ranges from a low of three data points to a high of one standard deviation above the median distance between adjacent retention times, and the search space for threshold ranges from a low of zero to a high of one point two times the median auto-threshold when using the median retention time difference as the peak width:

$$\frac{1}{2} ( ( 1 - {R}_{10} ) + {( 1 - P )}^{2} ) + C \frac{d}{{d}_{ma x}}$$

Further optimization settings may include an optimization parameter for whether to include shoulder peaks, and data-driven constraints for optimization with the goal of finding optimal parameters in as few iterations as possible by finding relationships between actual peak widths and the optimal peak width parameter, and finding relationships between existing auto-threshold values and the optimal detection threshold parameter.

In one working example using a challenging dataset, the optimised threshold decreased the number of false peaks by 22%, the number of missed peaks by 55%, and reduced the error in the total peak integration area by 60% compared to the existing processing method developed by the laboratory. This parameter optimisation approach enables the analytical integration tool 404 itself to identify peaks in a manner more consistent with laboratory SOPs, improving the baseline performance before any post-processing corrections are applied. This can reduce the need for manual review time on the back end.

The second category comprises SOP-specific ML correction models that, for each of the correction classes identified in the hierarchical labelling system, train a machine learning model that identifies the user preference for peak detection or integration and applies that correction to the analytical integration tool 404 output. These correction models address conceptual edits to a chromatogram that a user might make—such as adding a peak, removing a peak, merging two peaks or separating a peak into two, and modifying the definition of the baseline through more local or more global baseline marks. These models are necessary because there is often no way to define the rules that users employ in their standard operating procedures to manually correct integration problems, and oftentimes a peak will be corrected in a way that maintains consistency with legacy practices, representing human decisions rather than definitive truths.

The post-processing correction models enable the system to perform tasks that the analytical integration tool 404 was not designed to perform, adding capabilities that extend beyond conventional peak detection and integration. One such capability is integrating multiple peaks as a single peak, which is particularly valuable when impurities are clustered together and the analyst is only interested in the total amount of impurities rather than the amount of each individual impurity. The system can identify when two peaks should be merged into one, allowing the automated data review to recognise situations where multiple small impurity peaks in close proximity should be treated as a single integrated region for quantification purposes. This merging capability captures laboratory practices where the analytical question concerns aggregate impurity levels rather than individual impurity identification, a common scenario in pharmaceutical quality control where total impurity thresholds are specified rather than limits for each individual degradation product.

Another advanced capability enabled by the post-processing correction models is identifying a placeholder peak when a peak is missing in individual chromatograms within a series, where the peak is present in other chromatograms in the series. This allows the system to identify a valley in the chromatogram as a peak based on contextual information from the broader sample set. The correction models can add peaks that were missed by the analytical integration tool 404, and by learning from historical analyst behaviour across series of related chromatograms, the models can recognise patterns where analysts have manually added droplines to demarcate peaks in locations where the signal is weak or nonexistent because it has degraded but the peak appears in other samples from the same batch or study. This capability is particularly valuable for trace-level components that may fall below the detection threshold in some chromatograms due to sample-to-sample variability, instrument noise, or matrix effects, but which analysts know should be present and quantified based on the experimental context and the consistent appearance of the peak in replicate or related samples. This is also valuable for degradation studies where the drug substance is intentionally degraded, resulting in molecular changes that result in the absence of some peaks that would otherwise be present.

When a new chromatogram 414 is acquired and needs to be processed, it enters the trained system for automated analysis. The new chromatogram 414 represents routine analytical data from ongoing laboratory operations that requires peak detection, integration, and review. Unlike the training chromatograms which were used to teach the system how analysts integrate peaks, the new chromatogram represents a production sample that the system must process automatically without requiring manual intervention.

The new chromatogram 414 is processed by the same analytical integration tool 404 using the (now updated) parameters 406, generating new peak integrations 418. These new peak integrations 418 contain peak data from the analytical integration tool 404, including all the peak attributes and chromatographic properties that were computed for the training data. The new peak integrations 418 represent the initial automated analysis of the new chromatogram.

The new peak integrations 418 are then processed by the trained ML model(s) 410 to produce final peak integrations 420, which represent the improved integration results after applying the learnt correction models. The ML model(s) 410 analyse the new peak integrations 418 and apply adjustments based on the patterns learnt from historical analyst behaviour, automatically implementing the types of corrections that analysts would have made manually. These adjustments may include adding a peak, removing a peak, merging two peaks or separating a peak into two, and modifying the definition of the baseline through more local or more global baseline marks. The ML correction models capture SOP-specific integration characteristics, ensuring that the final peak integrations 420 are consistent with the laboratory's established practices and historical integration patterns.

As part of this process, the MMLPI may employ a review by exception process that employs an anomaly detection model to rank suspect injections by a learned priority score for targeted review based on historical review data. This capability serves as a quality control mechanism within the broader automated data review workflow, ensuring that peaks requiring human oversight are appropriately flagged even as the system automates the majority of routine processing tasks.

Whilst processing the new peak integrations 418 with the ML model(s) 410 to generate the final peak integrations 420, the system may apply the review by exception capabilities to flag peaks that require manual review. The chromatogram may be flagged due to anomalies in the raw signal or due to anomalies in how the chromatogram was integrated. The ML models for the review by exception process may be trained using a list of “reference” chromatograms such as the training chromatograms 402 (or other chromatograms specially selected for training the review by exception process). The training data may include reference chromatograms having peaks that are known to be representative of a particular analysis. Non-representative peaks may also be identified, and the model may be trained to recognize characteristics or attributes that contribute to a peak being considered non-representative (e.g., by identifying attributes or characteristics that are present in anomalous peaks that are not present in representative peaks, or vice versa).

For example, individual sites may have acceptance criteria designating whether a peak should be considered acceptable or anomalous. The site may have historical data that labels certain peaks as acceptable or representative, and other peaks as unacceptable or anomalous (e.g., passing vs failing the acceptance criteria). The review by exception models may learn a match score, such that the match score is higher for chromatograms that passed the site's acceptance criteria than for those that failed. This can be done even without having been trained on the actual acceptance criteria, demonstrating the model's ability to learn quality patterns from the data itself. This review by exception approach fundamentally transforms the data review workflow from a comprehensive manual process into a targeted, exception-based system where analyst expertise is focused precisely where it is most needed.

The model may assign a high score for chromatograms that match the peaks that passed the acceptance criteria in the reference set. The software uses an Isolation Forest ML model to assign a priority score to each chromatogram and provide a boxplot visualisation highlighting specific anomalous peak attributes that contributed to the score. This approach enables the system to learn what constitutes “normal” behaviour for a particular assay or standard operating procedure, and then identify deviations that warrant manual attention.

The system learns an anomaly detection model to guide data review and flag suspicious peak attributes after an improved integration. Rather than requiring analysts to review every single chromatogram—a process that is costly, time-consuming, and prone to inconsistency and user error—the system intelligently prioritises which injections require human review based on learnt patterns of what constitutes acceptable versus anomalous results.

The final peak integrations 420 represent the output of the Mathematical and Machine Learning Peak Integration system, providing peak detection and integration results that match analyst preferences without requiring manual review of every chromatogram. This ML-assisted post-processing approach provides more consistent, customised integrations whilst reducing analyst time and laboratory costs by automating the correction process that would otherwise require manual intervention. By learning from the historic manual integration corrections for similar chromatograms, the system eliminates the costly, time-consuming manual review process that is prone to inconsistency and user error, whilst maintaining or improving the quality and consistency of the integration results.

FIG. 5 illustrates the hierarchical labelling classification system used to categorise manual corrections made to peaks 502 during data review. The hierarchical structure begins with peak 502 as the root category, which branches into four primary categories: unchanged 504 (where the peak was not modified by the analyst), deleted 506 (where the analyst removed a peak detected by the analytical integration tool), added 508 (where the analyst manually added a peak not detected by the analytical integration tool), and modified 510 (where the analyst changed some aspect of a detected peak).

The deleted 506 category further subdivides into two specific types: merged 512 (where two or more peaks were combined into one) and renamed 514 (where the peak identifier was changed).

The added 508 category further subdivides into two specific types: split from existing 516 (where one peak was separated into multiple peaks) and skim from existing 518 (where a shoulder or minor peak was separated from a larger peak).

The modified 510 category further subdivides into two specific types: boundaries modified 520 (where the start or end time of the peak was adjusted) and Int Type changed 522 (where the integration type was modified).

This classification system enables the ML peak detection component to identify patterns in analyst behaviour and learn laboratory-specific integration practices for each type of correction. The hierarchical structure captures the conceptual edits to a chromatogram that a user might make, organising them in a way that reflects both the fundamental action taken (deletion, addition, or modification) and the specific nature of that action (such as merging, splitting, or boundary adjustment).

These labels may be added to the training data by an automated hierarchical labeling set of rules. The set of rules inputs peak data from the analytical integration tool and manual integration, then outputs a hierarchical “correction label” per peak that will be used to train a sequence of custom-tailored, SOP-specific ML integration correction models for a given site and assay.

The automated hierarchical labelling set of rules operates by comparing peak attributes between the analytical integration tool output and the manual integration stored in the history of manual corrections 408. The set of rules inputs peak attributes from the analytical integration tool and manual peak attributes, then outputs a correction label for each peak. For each peak in a chromatogram, the set of rules examines the differences between what the analytical integration tool detected and what the analyst ultimately recorded in the manual integration, systematically categorising the type of correction that was made.

The set of rules begins by determining whether a peak falls into one of the four primary categories: unchanged 504, deleted 506, added 508, or modified 510. To make this determination, the set of rules compares peak identifiers, retention times, and other attributes between the analytical integration set of rules output and the manual integration. If a peak appears in both the analytical integration tool output and the manual integration with matching identifiers and similar retention times, and if the peak attributes (such as start time, end time, area, and integration type) are substantially the same, the set of rules labels it as unchanged 504.

If a peak appears in the analytical integration tool output but does not appear in the manual integration (based on matching peak identifiers or retention time proximity), the set of rules categorises it as deleted 506. The set of rules then examines whether this deletion represents a more specific type of correction. If the deleted peak's area or retention time range has been incorporated into another peak in the manual integration, the set of rules labels it as merged 512, indicating that two or more peaks were combined into one. If the peak identifier was changed but the peak location and boundaries remain similar, the set of rules labels it as renamed 514.

Conversely, if a peak appears in the manual integration but does not appear in the analytical integration tool output, the set of rules categorises it as added 508. The set of rules then determines whether this addition represents a specific type of correction. If the added peak's retention time and boundaries fall within or adjacent to an existing peak in the analytical integration tool output, suggesting that the analyst separated one peak into multiple peaks, the set of rules labels it as split from existing 516. If the added peak represents a shoulder or minor peak that was separated from a larger peak, the set of rules labels it as skim from existing 518.

If a peak appears in both the analytical integration tool output and the manual integration with matching identifiers but with different attributes, the set of rules categorises it as modified 510. The set of rules then examines which specific attributes were changed to determine the subcategory. If the start time or end time of the peak was adjusted beyond a threshold tolerance, the set of rules labels it as boundaries modified 520. If the integration type parameter was changed (such as switching from valley-to-valley integration to baseline integration), the set of rules labels it as IntType changed 522.

By systematically comparing peak attributes between the analytical integration tool output and the manual integration for each peak in the training chromatograms 402, the automated hierarchical labelling set of rules generates a comprehensive dataset of correction labels that capture the patterns of analyst behaviour. These labels then serve as the training data for the SOP-specific ML correction models, enabling the system to learn which types of corrections analysts typically make under various chromatogram conditions and to automatically apply similar corrections to new chromatograms.

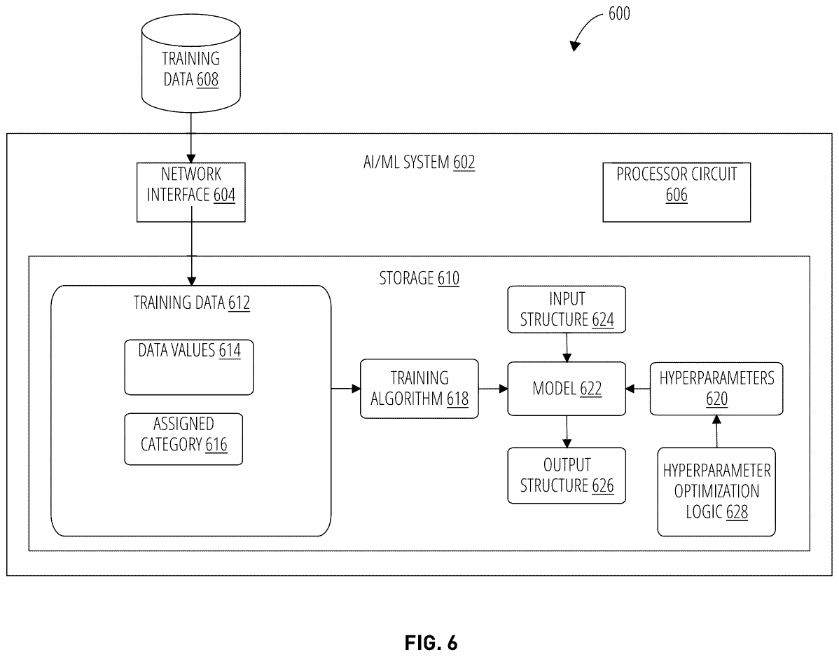

Exemplary embodiments may make use of artificial intelligence/machine learning (AI/ML). FIG. 6 depicts an AI/ML environment 600 suitable for use with exemplary embodiments.

At the outset it is noted that FIG. 6 depicts a particular AI/ML environment 600 and is discussed in connection with an XGBoost model. In particular, the depicted example can be implemented in Python using the XGBoost library for gradient boosting, scikit-optimize for Bayesian optimization, and scikit-learn for evaluation metrics. Numerical operations may use the NumPy and pandas libraries, with SciPy for signal processing. XGBoost models may use Bayesian hyperparameter optimization via Optuna with cross-validation. Models may support parallel processing for efficient computation on multi-core systems.

However, other AI/ML systems also exist, and one of ordinary skill in the art will recognize that AI/ML environments other than the one depicted may be implemented using any suitable technology.

At a high level, the AI/ML environment 600 provides a sequential machine learning pipeline for automated peak integration in liquid chromatography (or other analytical instrument-related fields) that learns from previously reviewed, manual integrations of chromatograms. The approach consists of an initial parameter optimization stage for the analytical integration tool's algorithm, followed by a series of gradient boosted tree models that iteratively refine the integration results and mimic manual user corrections. The pipeline accepts raw two-dimensional chromatogram data (time and signal arrays) along with a training set of manually-integrated peaks, and outputs fully-integrated peak tables with peak retention and boundary times, areas, heights, and baselines.

The workflow to create a new model uses a series of user inputs to provide training. First, the pipeline assumes that the training dataset is a sufficiently large (e.g., n>50) and representative set of manually-approved and consistently integrated samples from a single chromatographic test or assay. Additional input may be derived from existing parameters such as the integration start/stop boundaries and a retention time search window for a named component to use as a drift reference.

To take liquid chromatography as an example, peak integration is the process of identifying peaks in a chromatogram and quantifying their areas, which are proportional to analyte concentrations. A peak integration may consist of several key elements: (1) the start and end times that define the peak boundaries, (2) the apex location representing the maximum signal, and (3) the “integration type” that specifies how the baseline is constructed. The integration type determines how the area under the curve is calculated and is represented by a two-character code indicating the left and right boundary types. The three primary boundary types are: baseline (b), where the boundary intersects the raw signal; valley (v), where the boundary occurs at a local minimum between two peaks that share the same baseline; and tangent skim (t), where a tangent line is drawn between two points in the raw signal contained within a larger “parent” peak. Together, these two-character codes characterize the boundary behavior of peaks: e.g. “bb” for a standalone peak with both boundaries at baseline, “bv” or “vb” for edge peaks in a cluster that share the same baseline, and “vv” for interior peaks in a multi-peak cluster.

The AI/ML environment 600 may include an AI/ML System 602, such as a computing device that applies an AI/ML algorithm to learn relationships between the above-noted peak parameters.

The AI/ML System 602 may make use of training data 608. In some cases, the training data 608 may include pre-existing labeled data from databases, libraries, repositories, etc. The training data 608 may include, for example, rows and/or columns of data values 614. The training data 608 may be collocated with the AI/ML System 602 (e.g., stored in a Storage 610 of the AI/ML System 602), may be remote from the AI/ML System 602 and accessed via a Network Interface 604, or may be a combination of local and remote data. Each unit of training data 608 may be labeled with an assigned category 616 (or multiple assigned categories); for instance, each row and/or column may be labeled with a classification. In some embodiments, the training data may include individual data elements (e.g., not organized into rows or columns) and may be labeled on an individual basis.

As noted above, the AI/ML System 602 may include a Storage 610, which may include a hard drive, solid state storage, and/or random access memory.

The Training Data 612 may be applied to train a model 622. Depending on the particular application, different types of models 622 may be suitable for use. For instance, in the depicted example, an XGBoost model may be particularly well-suited to learning associations the data values 614 and the assigned category 616. Other types of models 622, or non-model-based systems, may also be well-suited to the tasks described herein, depending on the designers goals, the resources available, the amount of input data available, etc.

Any suitable Training Algorithm 618 may be used to train the model 622. Nonetheless, the example depicted in FIG. 6 may be particularly well-suited to a supervised training algorithm. For a supervised training algorithm, the AI/ML System 602 may apply the data values 614 as input data, to which the resulting assigned category 616 may be mapped to learn associations between the inputs and the labels. In this case, the assigned category 616 may be used as a labels for the data values 614.

The exemplary system described herein may use several different models 622 for different purposes, and the training algorithm 618 for each may therefore be different. An overview of the training of these different models is provided below.

### Analytical Integration Tool Parameter Optimization

The first stage of the model pipeline may optimize (e.g.) three parameters of the analytical integration tool peak detection algorithm: the peak width, detection threshold, and a boolean flag for whether to detect “shoulder” peaks. These parameters are tuned with a Bayesian optimization framework using Gaussian processes to maximize the overlap between the model integrations and ground-truth manual integrations.

The analytical integration tool algorithm may detect peaks by identifying local maxima in the second derivative with a minimum height above the “detection threshold” parameter. The second derivative is computed from the raw signal using a modified Savitzy-Golay filter with a width set by the “peak width” parameter. If two peaks are poorly resolved such that there is no local minimum in the raw signal between the two apices, The analytical integration tool refers to the boundary between them as a “shoulder.” By default, these peaks are merged together unless a “Detect Shoulders” event is declared to preserve the boundary. Accordingly, the third parameter in our optimization process is a Boolean value representing whether these shoulder peaks should be kept separate or merged.

The numerical parameters are conditioned with uniform priors acting as a search space, with boundaries defined based on the characteristics of the training data. For peak width, the upper bound is defined as one standard deviation above the median inter-peak spacing. For the detection threshold, the upper bound is set to 1.25 times the median automatic threshold determined by the analytical integration tool.

For each optimization iteration, detected peaks are co-identified with manually-integrated reference peaks from the same data in order to evaluate overall integration quality. A labeling algorithm processes each chromatogram independently and uses a greedy assignment strategy. For each manual peak, all detected peaks with apices falling between the manual peak's boundaries were considered overlapping candidates. Among overlapping candidates, the detected peak with the highest apex height is selected as the best match and labeled as a true positive (TP). If multiple manual peaks compete for the same detected peak, the pairing with the smallest difference in retention time is retained. Detected peaks with apices outside all manual peak boundaries are labeled as false positives (FP), while manual peaks without any overlapping detected peaks are labeled as false negatives (FN). Accordingly, the overall overlap between the manual integrations and the Apex Track integrations with the current parameter set can be expressed in terms of recall (TP/TP+FN) and precision (TP/TP+FP). These performance metrics are composed into a single objective function to minimize:

$${f}_{obj} = \frac{1}{2} ( ( 1 - {r}_{small} ) + {( 1 - p )}^{2} ) + k \frac{d}{{d}_{m ax}}$$

where rₛₘₐₗₗ is the recall for the smallest peaks in the manual dataset (defined as the bottom 5% by percent area and the bottom 5% by width), and p is the overall precision. This formulation prioritizes the detection of small peaks over the potential introduction of noise peaks since the partial derivative with respect to recall is constant while the partial derivative with respect to precision approaches 0 as precision approaches 1.0.

A regularization term k×d/dmaxk×d/dmax is added to penalize large parameter values, where d is the Euclidean distance from the current parameter values to the lower bounds of the search space, dₘₐₓ is the maximum possible distance defined by the search space, and

$$k = 0.025 .$$

Optimization uses a Lower Confidence Bound acquisition function (κ=1.5) with 50 initial random points and up to 75 total optimization iterations. Early stopping is applied if five consecutive iterations show improvement less than 0.0025 in the objective function.

### Feature Engineering

After initial peak detection with optimized parameters, the system compares each integration to its corresponding manual ground-truth integration and labels all peaks accordingly, extracting the true peak boundaries and integration-type codes as targets for subsequent models. It then extracts a comprehensive set of features to characterize each detected peak. Primary features include temporal characteristics (retention and apex times, start/end times, peak widths), amplitude features (height, area, and their percentage values), and integration types (baseline, valley, tangent skim, or negative peak). To represent peak shape information, the system computes derivative-based features from the smoothed chromatogram signal. For each peak, the inflection points (zeros of the second derivative) surrounding the apex are identified, as well as extrema in both the second and third derivatives. Specifically, the closest second derivative maxima outside the inflection region and the nearest third derivative maxima and minima are located, accounting for the odd symmetry of the third derivative around the peak. Boolean features indicate whether adjacent peaks share common derivative extrema to help characterize poorly-resolved peaks. All time-based features are then expressed relative to the retention time of a reference peak included as input by the user to account for retention time drift across samples. The output of this stage is a single dataframe where each row represents an individual peak.

### Dropline Removal Model

Many chromatographic peaks exhibit multiple local maxima that the analytical integration tool detects as separate peaks connected by valley boundaries (“droplines”) while sharing a common baseline. The dropline removal model determines which of these boundaries represent spurious splits that should be merged into a single peak. The inclusion of these extra droplines might occur due to the analytical integration tool-optimization stage favoring low thresholds to maximize recall for small peaks, or based on custom integration guidelines for a dataset from a site's standard operating procedures.

To predict whether to merge each pair of neighboring peaks, the system first reframes the feature data so that each sample represents an individual dropline, aggregating features from both of the adjacent peaks. These features include the boundary time and the following features from each peak: apex time, integration type, percent area, total width, inflection-point width, derivative minima and maxima, and Boolean features for shared derivative extrema. A binary XGBoost classifier is then trained to predict whether each dropline should be deleted (merged) or retained based on “false positive” labels from the corresponding manually integrations.

Given the potential for severe class imbalance, the system uses adaptive model selection: if positive cases (deletions) comprise less than 1% of the data or fewer than the number of cross-validation folds, the model is skipped with all droplines retained. For datasets with adequate balance, hyperparameters are optimized using the Optuna library with 3-fold cross-validation, maximizing the area under the ROC curve (AUC) for the predicted deletion probability.

Post-processing handles the merging of peaks connected by deleted droplines. When multiple consecutive peaks are merged, the system retains the integration type boundaries from the outermost peaks, sums areas and widths across the segment, and selects apex-related features from the highest peak in the cluster. The algorithm correctly handles transitive merges where deletions create chains of connected peaks.

### Integration Type Classification Model

The integration type model addresses several key integration tasks by predicting the appropriate two-character boundary type codes for each peak based on the corresponding manual integrations. We frame this as a multi-class classification problem using an XGBoost classifier with the following feature set for each peak as inputs: retention time, apex time, the start and end times of the cluster baseline, the time of the inflection points, the percent area, percent height, width, and inflection width.

The integration-type formulation handles multiple simultaneous peak edits including peak deletion, cluster merging/splitting, and conversion to tangent skim integration. Manual reviewers often delete spurious peaks that the analytical integration tool detects in baseline noise or artifacts. We represent deleted peaks (false positives) with a special “missing” integration type label, allowing the classifier to predict which peaks should be removed. When the model predicts that the outer boundary types of adjacent clusters should change from baseline (b) to valley (v), this indicates the separate clusters should be merged into a single cluster with a shared baseline. For example, if two consecutive peaks have integration types “bb” and “bb” but are predicted as “bv” and “vb”, we change their representation from two independent peaks to a single two-peak cluster. Conversely, when shared inner boundary types are predicted to change from valley (v) to baseline (b), this signals that a cluster should be split at the boundary. The model also predicts when tangent skim integration (t) is more appropriate than valley or baseline integration, such as when a small peak sits on the shoulder of a larger peak.

Integration-type classes with fewer than 1% representation or insufficient samples for cross-validation are excluded from training. The system then employs a multi-class XGBoost classifier when three or more classes remain after filtering, or binary classification for two classes. If only a single class remains, predictions default to that class without model training. Hyperparameters are optimized using the Optuna library with 3-fold cross-validation. For binary problems, the system uses the logistic objective and optimizes AUC; for multi-class problems, it uses the softmax objective and optimizes the macro F1 score.

After model training and prediction, a post-processing workflow updates peak boundaries according to the predicted integration types and corresponding integration edits. For example, changing a valley integration to baseline requires adjusting boundaries and recalculating areas. All derivative features and temporal characteristics are recomputed for peaks with modified boundaries to ensure consistency for downstream models.

### Boundary Time Adjustment Model

The final correction model fine-tunes the peak start and end times through a two-stage architecture. The system first reframes the peak-level feature data again so that each sample represents an individual boundary point, with each peak contributing up to two samples (start and end). Boundary characteristics are represented by the following feature set: boundary time, boundary type, the time to the nearest other boundaries (left and right), time to the nearest other local minima in the smoothed signal (left and right), and the following features for the nearest peaks to both the left and right: percent area, inflection width, inflection time, and Boolean representing whether the second-derivative maximum is shared. Time-based features are normalized relative to the boundary's current position.

The first model stage is a binary classifier that predicts whether a boundary should move at all. This addresses the distribution of boundary adjustments, which typically shows a large spike at zero (i.e. most boundaries predicted by the analytical integration tool are already correct). Hyperparameters are optimized using the Optuna library with 3-fold cross-validation to maximize AUC, followed by probability threshold tuning to maximize the F1 score.

The second stage is a regression model that predicts the magnitude and direction of the time shift for boundaries classified as needing adjustment in stage one. The model uses XGBoost with squared error loss and hyperparameters are optimized with the Optuna library to minimize RMSE with 3-fold cross-validation. Target labels are computed as the difference between manually-determined and currently detected boundary times.

Model training includes quality checks at multiple levels. The binary classifier is skipped if either class has insufficient representation (<1%) or if the total sample size is inadequate. The regression model is trained only on samples where the boundary should move (as determined by training labels during fitting or binary model predictions during inference) and is skipped if insufficient training data is available.

The Training Algorithm 618 may be applied using a Processor Circuit 606, which may include suitable hardware processing resources that operate on the logic and structures in the Storage 610. The Training Algorithm 618 and/or the development of the trained model 622 may be at least partially dependent on model Hyperparameters 620; in exemplary embodiments, the model Hyperparameters 620 may be automatically selected based on Hyperparameter Optimization logic 628, which may include any known hyperparameter optimization techniques as appropriate to the model 622 selected and the Training Algorithm 618 to be used. Typical hyperparameter search spaces include learning rate (0.01-0.5, log scale), maximum tree depth (3-10), minimum child weight (0-10), and subsample ratio (0.5-1.0). Optimization may run for (e.g.) 50 trials per model.

Optionally, the model 622 may be re-trained over time.

In some embodiments, some of the Training Data 612 may be used to initially train the model 622, and some may be held back as a validation subset. The portion of the Training Data 612 not including the validation subset may be used to train the model 622, whereas the validation subset may be held back and used to test the trained model 622 to verify that the model 622 is able to generalize its predictions to new data.

Once the model 622 is trained, it may be applied (by the Processor Circuit 606) to new input data. The new input data may include unlabeled data stored in a data structure, potentially organized into rows and/or columns. This input to the model 622 may be formatted according to a predefined input structure 624 mirroring the way that the Training Data 612 was provided to the model 622. The model 622 may generate an output structure 626 which may be, for example, a prediction of an assigned category 616 to be applied to the unlabeled input.

The above description pertains to a particular kind of AI/ML System 602, which applies supervised learning techniques given available training data with input/result pairs. However, the present invention is not limited to use with a specific AI/ML paradigm, and other types of AI/ML techniques may be used.

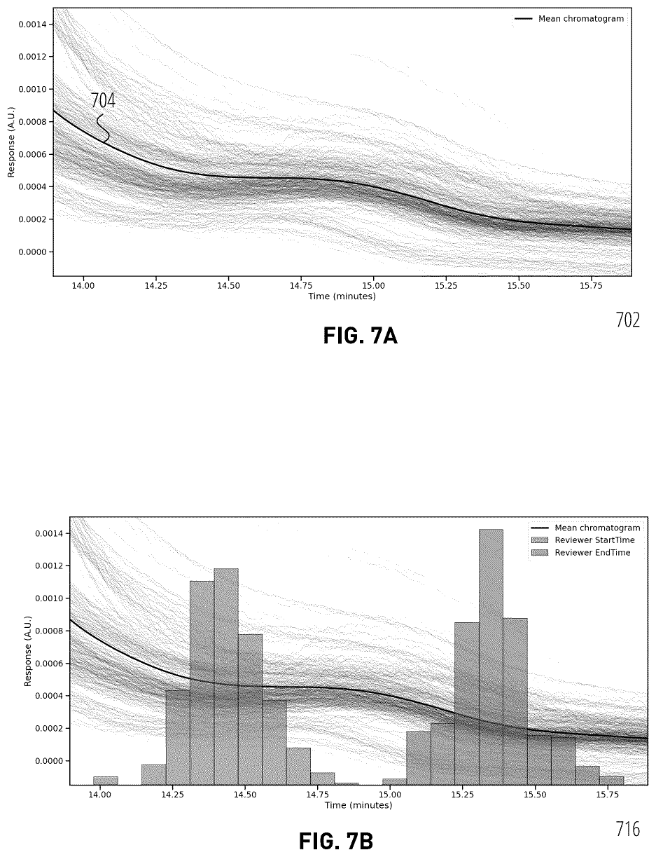

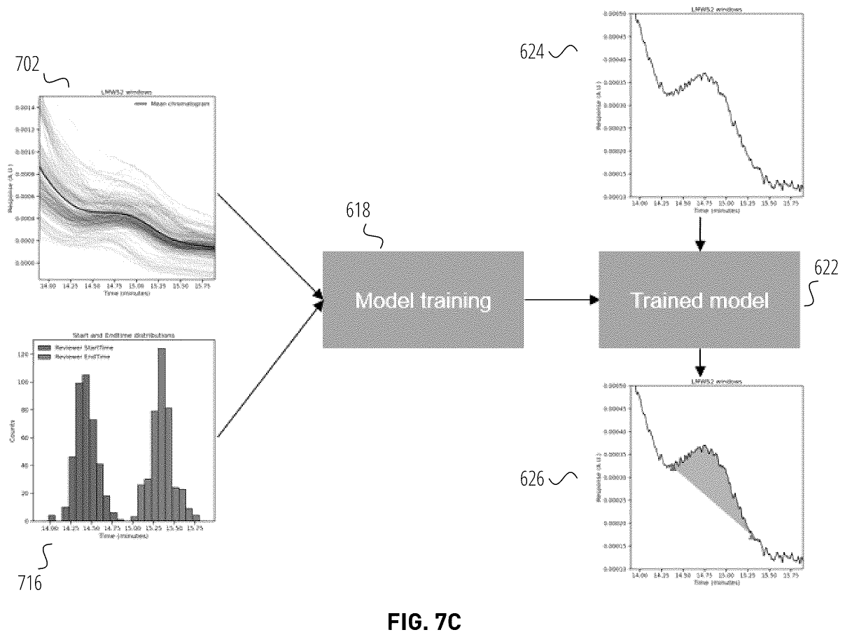

One working example showing how a system can learn, from historical data, how users of a particular lab have set peak boundaries is shown in FIG. 7A-FIG. 7C.

FIG. 7A illustrates aggregated chromatograms 702 and mean chromatogram 704 for a specific peak of interest (Peak 1) across multiple training chromatograms. The figure shows the response in absorbance units (A.U.) plotted against time in minutes, with the time range spanning from approximately 14.00 to 15.75 minutes. The aggregated chromatograms 702 represent multiple individual chromatograms overlaid to show the variability in peak shape, position, and intensity across different samples. The mean chromatogram 704 represents the average signal across all the aggregated chromatograms 702, providing a representative peak profile. This visualisation demonstrates the natural variation in chromatogram data that the ML peak detection component must account for when learning optimal detection thresholds and integration boundaries. The overlapping chromatograms show variation in peak height, width, and retention time, reflecting real-world analytical conditions including instrument variability, sample differences, and environmental factors.

FIG. 7B illustrates user corrections 716 applied to Peak 1, showing how analysts manually adjust or set peak boundaries during manual review. The figure displays the same mean chromatogram as FIG. 7A, but with the addition of histograms of reviewer StartTime and reviewer EndTime markers that indicate where analysts have manually defined the peak boundaries across each of the chromatograms in the set. These manual corrections, mined from history of manual corrections 408, represent the laboratory-specific standard operating procedures for integrating this particular peak. The distribution of reviewer StartTime and reviewer EndTime values across multiple training chromatograms provides the training data for machine learning models to learn how analysts determine peak boundaries. By analysing patterns in these manual corrections, the ML peak detection component can learn to predict appropriate peak start and end times that match analyst preferences, accounting for factors such as baseline definition, peak shape, and the presence of nearby peaks or noise.

FIG. 7C illustrates the model training process and trained model output for predicting peak boundaries. The figure shows aggregated chromatograms 702 with mean chromatogram 704, along with visualisations of the Training Algorithm 618 and trained model 622. The model training section shows how the Training Algorithm 618 processes the distribution of reviewer StartTime and reviewer EndTime values from user corrections 716 to learn patterns in analyst behaviour. The trained model 622 acts on the analytical model output (in this case that did not detect this skim peak), and adds the two peak boundaries consistent with the user corrected behavior from the training set. The input structure 624 and output structure 626 components indicate how chromatogram features are transformed into predicted peak boundaries for new chromatograms. The trained model can be applied to these new chromatograms to automatically predict peak boundaries that match laboratory-specific integration practices without requiring manual review.

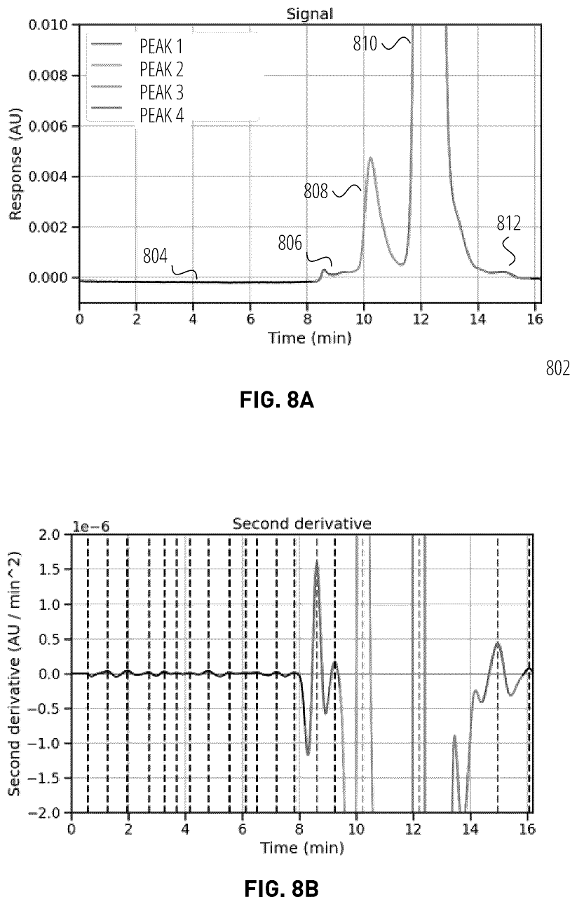

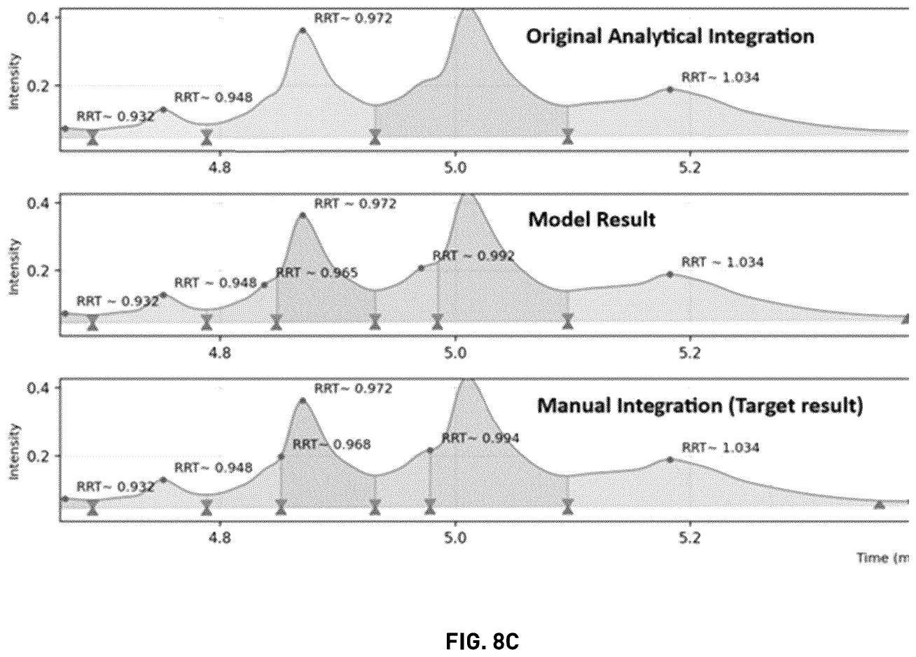

FIG. 8A-FIG. 8B provide a working example showing how manual corrections can be captured and used to train the ML model(s) 410.

FIG. 8A illustrates a chromatogram 802 showing a typical separation with multiple peaks of interest. The figure displays response in absorbance units (AU) plotted against time in minutes, spanning from 0 to 16 minutes. The chromatogram 802 includes baseline 804, first peak 806 (labelled Peak 1), second peak 808 (labelled Peak 2), third peak 810 (labelled Main Component, which is the largest peak), and fourth peak 812 (labelled Peak 3). This chromatogram represents a typical size-exclusion high-performance liquid Chromatography (SE-HPLC) separation where the main component is separated from impurities and degraded molecules. The chromatogram demonstrates the challenge of detecting and integrating peaks of varying sizes, where smaller peaks such as Peak 1 806 and Peak 3 812 may be difficult to distinguish from noise, whilst larger peaks such as the main component 810 are easily detected.

FIG. 8B illustrates the second derivative of the chromatogram signal shown in FIG. 8A, plotted as second derivative in AU/min² against time in minutes. The second derivative analysis is a fundamental technique used by analytical integration tools to identify peak locations, as peaks in the original chromatogram correspond to local maxima in the second derivative signal. The figure shows multiple second derivative maxima of varying heights, with larger maxima corresponding to more prominent peaks in the original chromatogram and smaller maxima potentially representing either small true peaks or noise. The analytical integration tool determines peak location by computing second-derivative heights and identifying points where the chromatogram's second derivative has a local minimum. The challenge illustrated by this figure is determining which second derivative maxima represent true peaks versus noise, which is addressed by the processing method optimisation component that learns optimal detection thresholds and peak widths to separate true peaks from noise based on second-derivative height.

FIG. 8C provides a comparison between automatic integration by the analytical integration tool and manual integration by an analyst, illustrating the types of corrections that the SOP-specific ML correction model learns to apply. The top panel shows the analytical integration tool result with automatically selected peaks, including the start and ends of the peaks. The bottom panel shows the manual integration result with manually adjusted peaks. The comparison demonstrates that whilst the analytical integration tool correctly identified a number of peaks, the analyst made specific corrections to the peak boundaries and added two skim peaks (Peaks 3 and 5 in the manual integration panel) that were not detected by the automatic algorithm. These types of corrections—adjusting peak boundaries and adding skim peaks—represent laboratory-specific integration practices that vary between analysts and methods. The ML correction model learns from such examples in the history of manual corrections 408 to automatically apply similar corrections to new chromatograms, capturing the nuanced standard operating procedures that cannot be encoded in fixed algorithm parameters. Thus, in the future the model result (middle panel) can more closely match the target result (bottom panel).

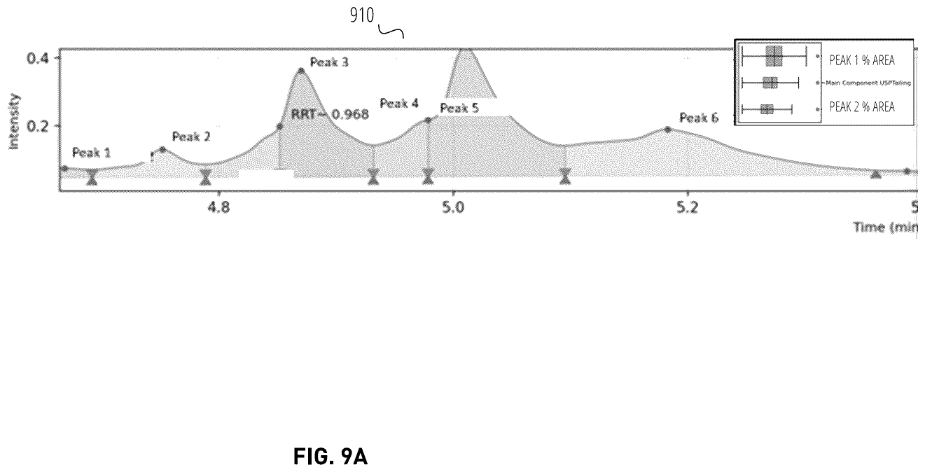

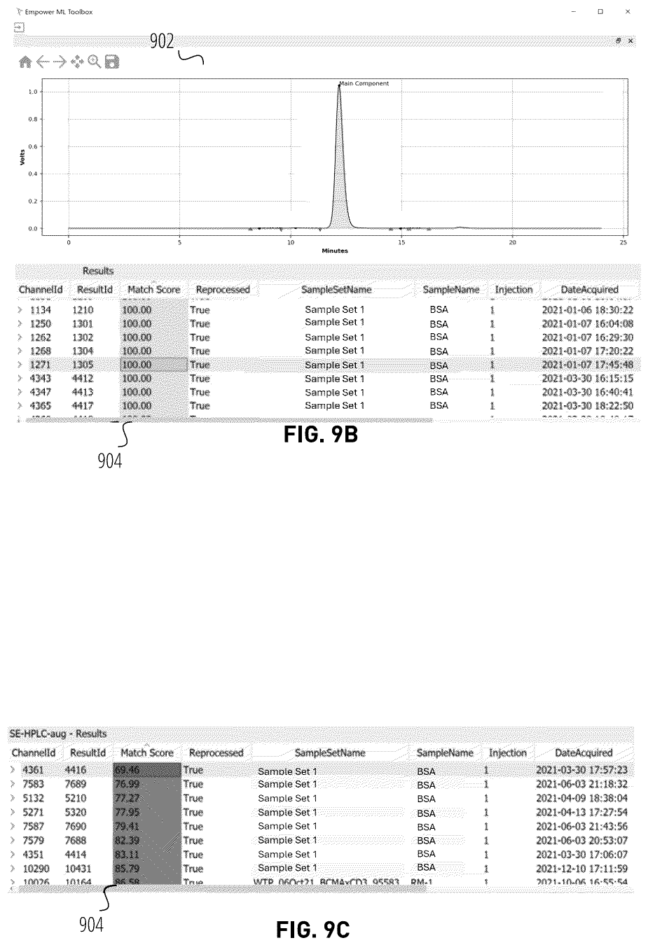

FIG. 9A-FIG. 9C show a working example of how peaks may be classified as representative (or non-anomalous, acceptable, etc.) versus non-representative (anomalous, unacceptable, etc.) for an automated review by exception process.

FIG. 9A illustrates representation 910 of a chromatogram with multiple peaks of interest, showing response in absorbance units (A.U.) plotted against time in minutes from 4.2 to 5.4 minutes. Optionally, the interface may identify specific peak attributes that are monitored by the ML review by exception component for anomaly detection, such as the percentage area of each peak, retention time, peak height, signal-to-noise ratio, and plate count, are extracted as features for the Isolation Forest anomaly detection model. By monitoring these attributes across multiple chromatograms, the ML review by exception component can identify chromatograms that deviate from the reference set, enabling targeted manual review of anomalous samples whilst allowing routine samples to proceed without analyst intervention.

FIG. 9B illustrates a user interface screenshot from the Empower ML Toolbox showing representative peaks 902 and match scores 904. The interface displays a chromatogram with the Main Component peak and several other peaks plotted as volts against minutes from 0 to 25 minutes. Below the chromatogram display is a results table showing multiple chromatograms with their associated metadata including ChannelId, ResultId, Match score, Reprocessed status, SampleSetName, SampleName, Injection number, DateAcquired, DateProcessed, and Processing Method. The match scores 904 shown in the table are all 100.00, indicating that these chromatograms are representative peaks 902 that closely match the reference set and have been assigned high priority scores by the ML review by exception component. This interface enables analysts to quickly identify which chromatograms have been automatically approved based on their similarity to the reference set, reducing the need for manual review of routine samples.

FIG. 9C illustrates a user interface screenshot from the Empower ML Toolbox showing non-representative peaks that have been flagged for review. The panel shows a results table with chromatograms ranked by their match scores, ranging from 69.46 to 86.58, which are significantly lower than the 100.00 scores shown in FIG. 9B for representative peaks 902. These lower scores indicate that these chromatograms are non-representative peaks that deviate from the reference set in one or more peak attributes. The highlighted chromatogram with the lowest score (69.46) can be displayed in a view similar to that of 902 in FIG. 9B, allowing the analyst to see which specific peak attributes contributed to the anomalous classification. This review by exception interface enables efficient targeted review by presenting analysts with only those chromatograms that require attention, along with visualisations indicating why each chromatogram was flagged, thereby reducing review time whilst maintaining data quality.

FIG. 10 illustrates one example of a system architecture and data processing device that may be used to implement one or more illustrative aspects described herein in a standalone and/or networked environment. Various network nodes, such as the data server 1010, web server 1006, computer 1004, and laptop 1002 may be interconnected via a wide area network 1008 (WAN), such as the internet. Other networks may also or alternatively be used, including private intranets, corporate networks, LANs, metropolitan area networks (MANs) wireless networks, personal networks (PANs), and the like. Network 1008 is for illustration purposes and may be replaced with fewer or additional computer networks. A local area network (LAN) may have one or more of any known LAN topology and may use one or more of a variety of different protocols, such as ethernet. Devices data server 1010, web server 1006, computer 1004, laptop 1002 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1010, web server 1006, and client computer 1004, laptop 1002. Data server 1010 provides overall access, control and administration of databases and control software for performing one or more illustrative aspects described herein. Data serverdata server 1010 may be connected to web server 1006 through which users interact with and obtain data as requested. Alternatively, data server 1010 may act as a web server itself and be directly connected to the internet. Data server 1010 may be connected to web server 1006 through the network 1008 (e.g., the internet), via direct or indirect connection, or via some other network. Users may interact with the data server 1010 using remote computer 1004, laptop 1002, e.g., using a web browser to connect to the data server 1010 via one or more externally exposed web sites hosted by web server 1006. Client computer 1004, laptop 1002 may be used in concert with data server 1010 to access data stored therein, or may be used for other purposes. For example, from client computer 1004, a user may access web server 1006 using an internet browser, as is known in the art, or by executing a software application that communicates with web server 1006 and/or data server 1010 over a computer network (such as the internet).

Servers and applications may be combined on the same physical machines, and retain separate virtual or logical addresses, or may reside on separate physical machines. FIG. 10 illustrates just one example of a network architecture that may be used, and those of skill in the art will appreciate that the specific network architecture and data processing devices used may vary, and are secondary to the functionality that they provide, as further described herein. For example, services provided by web server 1006 and data server 1010 may be combined on a single server.

Each component data server 1010, web server 1006, computer 1004, laptop 1002 may be any type of known computer, server, or data processing device. Data server 1010, e.g., may include a processor 1012 controlling overall operation of the data server 1010. Data server 1010 may further include RAM 1016, ROM 1018, network interface 1014, input/output interfaces 1020 (e.g., keyboard, mouse, display, printer, etc.), and memory 1022. Input/output interfaces 1020 may include a variety of interface units and drives for reading, writing, displaying, and/or printing data or files. Memory 1022 may further store operating system software 1024 for controlling overall operation of the data server 1010, control logic 1026 for instructing data server 1010 to perform aspects described herein, and other application software 1028 providing secondary, support, and/or other functionality which may or may not be used in conjunction with aspects described herein. The control logic may also be referred to herein as the data server software control logic 1026. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 1032 and a second database 1030. In some embodiments, the first database may include the second database (e.g., as a separate table, report, etc.). That is, the information can be stored in a single database, or separated into different logical, virtual, or physical databases, depending on system design. Web server 1006, computer 1004, laptop 1002 may have similar or different architecture as described with respect to data server 1010. Those of skill in the art will appreciate that the functionality of data server 1010 (or web server 1006, computer 1004, laptop 1002) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The described technology includes several components, such as the review by exception component, peak detection component, hierarchical labeling component, etc. It is contemplated that these components may be used individually to obtain the advantages described herein, or in combination to achieve further synergies. The technology may be embodied in the following sample claims:

1. A computer-implemented method for automated chromatographic peak detection and integration, comprising:
(a) obtaining a training dataset comprising: (i) chromatographic data from a plurality of chromatograms; (ii) initial peak detection and integration outputs generated by an analytical integration tool that identifies peak locations in the chromatograms using peak detection parameters; and (iii) manual correction data for the initial peak detection and integration outputs;
(b) training a machine learning model using the initial peak detection and integration outputs from the analytical integration tool and the manual correction data;
(c) receiving a new chromatogram to be analysed;
(d) processing the new chromatogram using the analytical integration tool to generate initial peak detection and integration outputs for the new chromatogram;
(e) applying the trained machine learning model to the initial peak detection and integration outputs to generate corrected peak detection and integration outputs; and
(f) outputting the corrected peak detection and integration outputs for the new chromatogram.

2. The computer-implemented method of claim 1, further comprising adjusting the peak detection parameters using the machine learning model, the adjusting configured to preserve the initial peak detection and integration outputs when valid, and adjust the initial peak detection and integration outputs when corrections are predicted to be necessary based on user behaviour patterns learned by the machine learning model.

3. The computer-implemented method of any of claims 1-2, further comprising: automatically categorising the manual correction data using a hierarchical labelling set of rules that inputs peak attributes from the analytical integration tool and manual correction data, and outputs a hierarchical correction label for each peak.

4. The computer-implemented method of any of claims 1-3, wherein the analytical integration tool generates metadata alongside the peak locations, and the machine learning model is trained using the metadata.

5. The computer-implemented method of any of claims 1-4, wherein the manual correction comprises user-generated modifications to the initial peak detection and integration outputs retrieved from a history of manual corrections.

6. The computer-implemented method of any of claims 1-5, wherein the machine learning model is an ensemble machine learning model.

7. The computer-implemented method of any of claims 1-6, wherein the machine learning model applies a boosting paradigm in which weak learners comprising decision trees are sequentially applied to the initial peak detection and integration outputs, with each decision tree correcting the output of a previous decision tree

8. The computer-implemented method of any of claims 1-7, wherein the machine learning model is trained to reflect site-specific and assay-specific standard operating procedures learned from the manual correction data.

9. The computer-implemented method of any of claims 1-8, wherein training the machine learning model comprises: identifying candidate peaks by computing second-derivative heights of the chromatograms; labelling the candidate peaks as “true” or “noise” based on the manual correction data; and determining threshold value separating the true peaks from the noise peaks.

10. The computer-implemented method of claim 9, wherein determining the optimal threshold comprises training a Bayesian logistic regression model that incorporates prior information from an automatic threshold algorithm of the analytical integration tool and returns a probability and confidence interval for each candidate peak.

11. The computer-implemented method of any of claims 1-10, wherein the machine learning model comprises a peak boundary model trained to predict start and end times of peaks by learning how reviewers integrate peaks whilst accounting for variance in input signal and variance in reviewer behaviour.

12. The computer-implemented method of any of claims 1-11, further comprising: receiving a set of reference chromatograms for the given assay; training an anomaly detection model using an Isolation Forest machine learning algorithm; assigning a priority score to each new chromatogram, wherein the priority score is high for chromatograms that match the reference set and low for anomalous chromatograms that differ from the reference set; and providing a visualisation highlighting specific anomalous peak attributes that contributed to the priority score.

13. The computer-implemented method of any of claims 1-12, further comprising validating the anomaly detection model, wherein the validating comprises: selecting a reference set of chromatograms that pass predefined acceptance criteria based on attributes of peaks and column backpressure; and evaluating whether normal chromatograms receive a high score and anomaly chromatograms receive a low score.

14. A non-transitory computer readable medium storing instructions that, when executed by one or more processors, cause the one or more processors to perform the method of any of claims 1-13.

15. A system comprising one or more processors and a non-transitory computer readable medium storing instructions that, when executed by the one or more processors, cause the one or more processors to perform the method of any of claims 1-13.

### LISTING OF DRAWING ELEMENTS

102 sample
104 liquid chromatograph
106 injector
108 pump
110 column
112 mass spectrometer
114 injector
116 ion guide
118 collision cell
120 mass analyzer
122 detector
124 raw data store
126 acquisition device
128 document store
130 metadata catalog
132 client browser
134 audit log
202 workflow
204 input
206 sample set
208 processing method
210 result set
212 initialization stage
214 channel processing stage
216 integration stage
218 identification stage
220 calibration stage
222 quantitation stage
224 summary stage
226 processed channels
228 peak table
230 component table
232 calibration table
234 update
236 summary results
238 step boundary
302 manual processing development block
304 integration by analytical integration tool block
306 manual review and integration block
308 manual integration (at set-up) block
310 processing method optimization block
312 SOP-specific ML correction model
314 automated data review block
402 training chromatograms
404 analytical integration tool
406 parameters/thresholds
408 history of manual corrections
410 ML model(s)
412 metadata
414 new chromatogram
416 peak integrations
418 new peak integrations
420 final peak integrations
502 peak
504 unchanged
506 deleted
508 added
510 modified
512 merged
514 renamed
516 split from existing
518 skim from existing
520 boundaries modified
522 IntType changed
600 AI/ML environment
602 AI/ML System
604 Network Interface
606 Processor Circuit
608 training data
610 Storage
612 Training Data
614 data values
616 assigned category
618 Training Algorithm
620 Hyperparameters
622 model
624 input structure
626 output structure
628 Hyperparameter Optimization logic
702 aggregated chromatograms
704 mean chromatogram
716 user corrections
802 chromatogram
804 baseline
806 first peak
808 second peak
810 third peak
812 fourth peak
814 first detected peak
816 second detected peak
818 third detected peak
820 fourth detected peak
822 first rejected peak
824 second rejected peak
826 noise peaks
828 true peaks
830 optimal threshold
832 automatically selected end of first peak
834 skim peak
836 manually adjusted end of first peak
838 manually added start of skim peak
840 manually added end of skim peak
902 representative peaks
904 match scores
906 non-representative peaks
910 representation
1002 laptop
1004 computer
1006 web server
1008 network
1010 data server
1012 processor
1014 network interface
1016 RAM
1018 ROM
1020 input/output interfaces
1022 memory
1024 operating system software
1026 control logic
1028 other application software
1030 second database
1032 first database

What is claimed is:

1. A computer-implemented method for automated peak detection and integration, comprising:
(a) obtaining a training dataset comprising: (i) analytical instrument data from a plurality of analytical traces; (ii) initial peak detection and integration outputs generated by an analytical integration tool that identifies peak locations in the analytical instrument data using peak detection parameters; and (iii) manual correction data for the initial peak detection and integration outputs;
(b) training a machine learning model using the initial peak detection and integration outputs from the analytical integration tool and the manual correction data;
(c) receiving a new analytical trace to be analysed;
(d) processing the new analytical trace using the analytical integration tool to generate initial peak detection and integration outputs for the new analytical trace;
(e) applying the trained machine learning model to the initial peak detection and integration outputs to generate corrected peak detection and integration outputs; and
(f) outputting the corrected peak detection and integration outputs for the new analytical trace.

2. The computer-implemented method of claim 1, further comprising adjusting the peak detection parameters using the machine learning model, the adjusting configured to preserve the initial peak detection and integration outputs when valid, and adjust the initial peak detection and integration outputs when corrections are predicted to be necessary based on user behaviour patterns learned by the machine learning model.

3. The computer-implemented method of claim 1, further comprising: automatically categorising the manual correction data using a hierarchical labelling set of rules that inputs peak attributes from the analytical integration tool and manual correction data, and outputs a hierarchical correction label for each peak.

4. The computer-implemented method of claim 1, wherein the analytical integration tool generates metadata alongside the peak locations, and the machine learning model is trained using the metadata.

5. The computer-implemented method of claim 1, wherein the manual correction comprises user-generated modifications to the initial peak detection and integration outputs retrieved from a history of manual corrections.

6. The computer-implemented method of claim 1, wherein the machine learning model is an ensemble machine learning model.

7. The computer-implemented method of claim 1, wherein the machine learning model applies a boosting paradigm in which weak learners comprising decision trees are sequentially applied to the initial peak detection and integration outputs, with each decision tree correcting the output of a previous decision tree.

8. The computer-implemented method of claim 1, wherein the machine learning model is trained to reflect site-specific and assay-specific standard operating procedures learned from the manual correction data.

9. The computer-implemented method of claim 1, wherein training the machine learning model comprises: identifying candidate peaks by computing second-derivative heights of the analytical traces; labelling the candidate peaks as “true” or “noise” based on the manual correction data; and determining threshold value separating the true peaks from the noise peaks.

10. The computer-implemented method of claim 9, wherein determining the optimal threshold comprises training a Bayesian logistic regression model that incorporates prior information from an automatic threshold algorithm of the analytical integration tool and returns a probability and confidence interval for each candidate peak.

11. The computer-implemented method of claim 1, wherein the machine learning model comprises a peak boundary model trained to predict start and end times of peaks by learning how reviewers integrate peaks whilst accounting for variance in input signal and variance in reviewer behaviour.

12. The computer-implemented method of claim 1, further comprising: receiving a set of reference analytical traces for the given assay; training an anomaly detection model using an Isolation Forest machine learning algorithm; assigning a priority score to each new analytical trace, wherein the priority score is high for analytical traces that match the reference set and low for anomalous analytical traces that differ from the reference set; and providing a visualisation highlighting specific anomalous peak attributes that contributed to the priority score.

13. The computer-implemented method of claim 12, further comprising validating the anomaly detection model, wherein the validating comprises: selecting a reference set of analytical traces that pass predefined acceptance criteria based on attributes of peaks and column backpressure; and evaluating whether normal analytical traces receive a high score and anomaly analytical traces receive a low score.

14. A non-transitory computer-readable storage medium, the computer-readable storage medium including instructions that when executed by a computer, cause the computer to:
(a) obtaining a training dataset comprising: (i) analytical instrument data from a plurality of analytical traces; (ii) initial peak detection and integration outputs generated by an analytical integration tool that identifies peak locations in the analytical traces using peak detection parameters; and (iii) manual correction data for the initial peak detection and integration outputs;
(b) train a machine learning model using the initial peak detection and integration outputs from the analytical integration tool and the manual correction data;
(c) receive a new analytical trace to be analysed;
(d) process the new analytical trace using the analytical integration tool to generate initial peak detection and integration outputs for the new analytical trace;
(e) apply the trained machine learning model to the initial peak detection and integration outputs to generate corrected peak detection and integration outputs; and
(f) output the corrected peak detection and integration outputs for the new analytical trace.

15. The computer-readable storage medium of claim 14, wherein the instructions further configure the computer to adjust the peak detection parameters using the machine learning model, the adjusting configured to preserve the initial peak detection and integration outputs when valid, and adjust the initial peak detection and integration outputs when corrections are predicted to be necessary based on user behaviour patterns learned by the machine learning model.

16. The computer-readable storage medium of claim 14, wherein the instructions further configure the computer to: automatically categorise the manual correction data using a hierarchical labelling set of rules that inputs peak attributes from the analytical integration tool and manual correction data, and outputs a hierarchical correction label for each peak.

17. The computer-readable storage medium of claim 14, wherein the analytical integration tool generates metadata alongside the peak locations, and the machine learn model is trained using the metadata.

18. The computer-readable storage medium of claim 14, wherein the manual correction comprises user-generated modifications to the initial peak detection and integration outputs retrieved from a history of manual corrections.

19. The computer-readable storage medium of claim 14, wherein the machine learn model is an ensemble machine learning model.

20. A computing apparatus comprising:
a processor; and
a memory storing instructions that, when executed by the processor, configure the apparatus to:
(a) obtain a training dataset comprising: (i) analytical instrument data from a plurality of analytical traces; (ii) initial peak detection and integration outputs generated by an analytical integration tool that identifies peak locations in the analytical traces using peak detection parameters; and (iii) manual correction data for the initial peak detection and integration outputs;
(b) train a machine learning model using the initial peak detection and integration outputs from the analytical integration tool and the manual correction data;
(c) receive a new analytical trace to be analysed;
(d) process the new analytical trace using the analytical integration tool to generate initial peak detection and integration outputs for the new analytical trace;
(e) apply the trained machine learning model to the initial peak detection and integration outputs to generate corrected peak detection and integration outputs; and
(f) output the corrected peak detection and integration outputs for the new analytical trace.
